(19) United States
(12) Patent Application Publication
(10) Pub. No.: US 2006/0051646 A1
(43) Pub. Date: Mar. 9, 2006

(54) Proton-conductive material and method for production thereof, membrane electrode assembly, and fuel cell

(76) Inventors: Wataru Kikuchi, Minami-ashigara-shi (JP); Koji Wariishi, Haibara-gun (JP)

Correspondence Address: BRINKS HOFER GILSON & LIONE, P.O. BOX 10395, CHICAGO, IL, 60610, US

(21) Appl. No.: 11/218,297

(22) Filed: Sep. 1, 2005

(30) Foreign Application Priority Data
Sep. 1, 2004 (JP) 253786/2004

(51) Int. Cl. H01M 8/10; C08J 5/20

(52) U.S. Cl. 429/33; 521/25; 429/313

(57) ABSTRACT

A proton-conductive material which contains a compound having a mesogen substituted with an electron-attracting group. The proton-conductive material has a high ionic conductivity, a small methanol crossover, and a high film strength.

This application claims priority to JP 253786/2004 filed Sep. 1, 2004, the entire contents of each are incorporated herein by reference.

### TECHNICAL FIELD

The present invention relates to a proton-conductive material and a method for producing it, to a membrane electrode assembly comprising the proton-conductive material, and to a fuel cell comprising the membrane electrode assembly.

### BACKGROUND

These days it is expected that solid polymer fuel cells will be put into practical use for, for example, power sources for household use and power sources to be mounted on vehicles as clean power-generating devices that are ecological to the global environment. The main stream of such solid polymer fuel cells is toward those that require hydrogen and oxygen as the fuel thereof. Recently, a direct methanol fuel cell (DMFC) has been proposed, in which methanol is used in place of hydrogen for fuel. This is expected to give high-capacity batteries for mobile devices that are substitutable for lithium secondary batteries, and is now much studied in the art.

The important functions of the electrolytic membrane (proton conductor) for solid polymer fuel cells are to physically insulate the fuel (e.g., hydrogen, aqueous methanol solution) fed to the anode, catalyst electrode from the oxidizing gas (e.g., oxygen) fed to the cathode, to electrically insulate the anode from the cathode, and to transmit the proton having been formed on the anode to the cathode. To fulfill these functions, the electrolytic membrane must have some mechanical strength and good proton conductivity.

In the electrolytic membrane for solid polymer fuel cells, generally used is a sulfonic acid group-having perfluorocarbon polymer such as typically Nafion®. The electrolytic membrane of the type has good ionic conductivity and has relatively high mechanical strength, but has some problems to be solved such as those mentioned below. Concretely, in the electrolytic membrane, water and the sulfonic acid group form cluster channels, and protons move in the cluster channels via water therein. Therefore, the ionic conductivity of the membrane significantly depends on the water content thereof that is associated with the humidity in the service environment in which the cells are driven. For poisoning reduction in the catalyst electrode with CO and for activation of the catalyst electrode therein, solid polymer fuel cells are preferably driven at a temperature falling within a range of from 100 to 150° C. However, within such a middle-temperature range, the water content of the electrolytic membrane in the cells lowers with the reduction in the ionic conductivity thereof, and therefore the expected cell characteristics could not be obtained. In addition, the softening point of the electrolytic membrane is around 120° C. and when the cells are driven at a temperature around it, then the mechanical strength of the electrolytic membrane is unsatisfactory. On the other hand, when the electrolytic membrane of the type is used in DMFC, then it causes various problems such as those mentioned below. Naturally, the barrier ability of the membrane against the fuel methanol is not good as the membrane readily absorbs water, and therefore methanol having been fed to the anode penetrates through the electrolytic membrane to reach the cathode. Owing to it, the cell output power lowers, and this is referred to as a methanol-crossover phenomenon. For practical use of DMFC, this is one important problem to be solved.

There is a growing tendency for the development of other proton-conductive materials substitutable for Nafion®, and some hopeful electrolytic materials have been proposed. For example, for easy film formation based on the good characteristics of inorganic material, one proposal is a nanocomposite material hybridized with polymer material. For example, disclosed is a method of forming a proton conductor by hybridizing a polymer compound having a sulfonic acid group in the side branches, a silicon compound and a proton acid (JP-A 2001-307752). Another proposal is an organic-inorganic nanohybrid proton-conductive material that is obtained through sol-gel reaction of a precursor, organic silicon compound in the presence of a proton acid (Japanese Patent No. 3,103,388; German Patent DE 10061920A1; JP-A2004-143446; Electrochimica Acta, 1988, Vol.43, Nos. 10-11, p. 1301; Industrial Material, by Nikkan Kogyo Shinbun, 2002, Vol. 50, p. 39; Solid State Ionics, 2001, No. 145, p. 127). These organic-inorganic composite and hybrid proton-conductive materials comprise an inorganic component and an organic component, in which the inorganic component comprises silicic acid and proton acid and serves as a proton-conductive site and the organic component serves to make the materials flexible. When the inorganic component is increased so as to increase the proton conductivity of the membranes formed of the material, then the mechanical strength of the membranes lowers. On the other hand, however, when the organic component is increased so as to increase the flexibility of the membranes, then the proton conductivity of the membranes lowers. Therefore, the materials that satisfy the two characteristics are difficult to obtain.

### SUMMARY

As a result of our studies, we, the present inventors have found that, when hydrogen oxide is used in the process of producing an electrolytic membrane, then the mesogen orientation in the membrane produced lowers and therefore the durability of the membrane tends to lower. We have further studied so as to clarify the reason for it, and, as a result, have found the following: A hydrogen peroxide radical readily reacts with an aromatic hydrocarbon compound that is poorly resistant to oxidation, and the skeleton of an organosilicon compound varies with the oxidation reaction on a sulfonic acid group, therefore causing the mesogen orientation reduction and the durability reduction.

Accordingly, an object of the invention is to provide a proton-conductive material having good flexibility and good mechanical strength, having good proton conductivity and having low methanol perviousness suitable for use in DMFC, and to provide a fuel cell comprising the material.

As a result of our assiduous studies in consideration of the above-mentioned object, we, the present inventors have found that, when the decomposition in precursor oxidation is prevented so as to improve the durability, then the above-mentioned problems can be solved. Specifically, we have found that, in a sol-gel reaction process of an organosilicon compound having a mesogen substituted with an electron-attracting group and a compound having a proton-donating group or its precursor, when the decomposition is prevented in the precursor oxidation stage, then an oriented aggregate can be formed not causing damage to the organosilicon molecules, and therefore an organic-inorganic hybrid membrane can be formed that has high proton conductivity and low methanol perviousness owing to the fixed satisfactory proton donor therein. On the basis of these findings, we have reached the present invention.

The object of the invention can be attained by the following constitution:

[1] A proton-conductive material which contains a compound having a mesogen substituted with an electron-attracting group.

[2] The proton-conductive material, which contains a compound having a structure wherein both an organic molecular chain containing a mesogen substituted with an electron-attracting group and a group containing a proton-donating group bond to a silicon-oxygen three-dimensional crosslinked matrix through a covalent bond.

[3] The proton-conductive material, which contains aggregate having a structure wherein both an organic molecular chain containing a mesogen substituted with an electron-attracting group and a group containing a proton-donating group bond to a silicon-oxygen three-dimensional crosslinked matrix through a covalent bond, and wherein at least a part of the organic molecular chain is oriented.

[4] The proton-conductive material of any one of [1] to [3], wherein the electron-attracting group is at least one or more of F, Cl, Br, I, CN, NO₂, COCH₃, CₙF₂ₙ₊₁ (where n indicates an integer of from 1 to 4), and SO₃H.

[5] The proton-conductive material of [2] or [3], wherein the proton-donating group is a sulfonic acid group.

[6] The proton-conductive material of any one of [1] to [3], wherein the mesogen is represented by any of the following formulae (A-1) to (A-5): 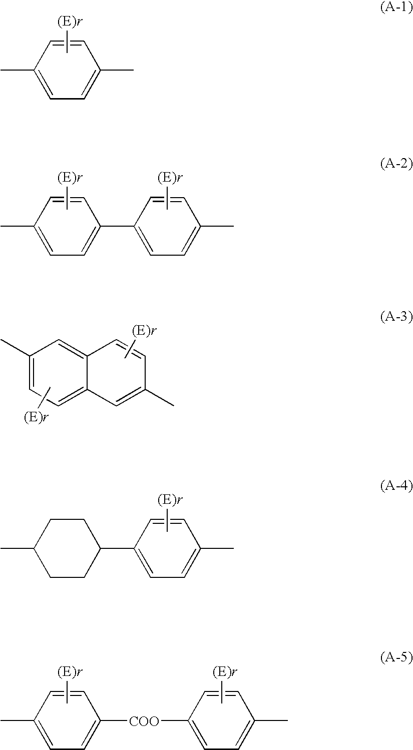
wherein E represents an electron-attracting group, and r indicates an integer of 1 or more.

[7] A method for producing a proton-conductive material, which comprises reacting and polymerizing a compound of the following formula (1) and an oxide of a compound of the following formula (3) in a mode of sol-gel reaction:
(Z¹)ₙ₁-A¹-[Si(OR¹)ₘ₁(R²)₃₋ₘ₁]ₙ₂ (1)
wherein A¹ represents an organic group containing a mesogen substituted with at least one electron-attracting group; R¹ represents an alkyl group or an aryl group; R² represents an alkyl group, an aryl group, or a heterocyclic group; Z¹ represents a substituent capable of forming a carbon-carbon bond or a carbon-oxygen bond through polymerization; ml indicates an integer of from 1 to 3; n2 indicates an integer of from 1 to 3; when the formula has two or more Z¹'s, R¹'s and R²'s, then they may be the same or different; and n1 indicates an integer of from 0 to 3,
L-(S)ₚ-B-[Si(OR³)₃₋ₘ₂(R⁴)ₘ₂]ₙ₂ (3)
wherein B represents an organic group containing an aliphatic group and/or an aromatic group; R³ represents an alkyl group or an aryl group; R⁴ represents an alkyl group, an aryl group or a heterocyclic group; m2 indicates an integer of from 1 to 3; n2 indicates an integer of from 1 to 4; p indicates an integer of from 1 to 5; when p is 1, then L represents a hydrogen atom or —COCH₃, and when p is an integer of from 2 to 5, then L represents an alkyl group, an aryl group, a heterocyclic group, or [Si(OR³)₃₋ₘ₂(R⁴)ₘ₂]ₙ₂; when the formula has two or more R³'s and R⁴'s, then they may be the same or different.

[8] The method for producing a proton-conductive material of [7], wherein the oxide of a compound of formula (3) contains a sulfone group.

[9] The method for producing a proton-conductive material of [7] or [8], wherein a mixture of a compound of formula (1) and an oxide of a compound of formula (3) is cast on a support and reacted in a mode of sol-gel reaction thereon.

[10] The method for producing a proton-conductive material of [7], wherein a mixture of a compound of formula (1), a compound of formula (3) and an oxidizing agent is cast on a support and reacted in a mode of sol-gel reaction thereon.

[11] The method for producing a proton-conductive material of any one of [7] to [10], wherein the support is a support processed for orientation.

[12] A membrane electrode assembly which has the proton-conductive material of [1] between the anode and the cathode.

8 13] A fuel cell which has the membrane electrode assembly of [12].

Having a mesogen substituted with an electron-attracting group, the proton conductor of the invention is free from the problem of compound decomposition in the process of oxidation of organosilicon compound, and therefore has the advantages of low methanol perviousness and high proton conductivity. In addition, since the membrane structure change owing to decomposition is small, acid release from the membrane is small and the membrane is therefore flexible and has good mechanical strength. Accordingly, when the membrane is used in direct methanol fuel cells, it enables higher output power than conventional proton conductors. In addition, when an aggregate where at least a part of organic molecular chains are oriented is formed in the conductor material, then the ionic conductivity of the material is higher and the resistance thereof to aqueous methanol is higher. In the case, therefore, the methanol crossover is reduced and the voltage reduction ratio is also reduced.

### BRIEF DESCRIPTION OF THE DRAWINGS

FIG. 1 is a schematic view of a stainless cell to which the reinforced membrane tested in the examples mentioned below is fitted.

In the drawing, 1 is a proton conductor; 2 is a reinforcing Teflon tape; 3 is a path for aqueous methanol injection; 4 is a carrier gas inlet slit; 5 is a detection slit (connected to a gas chromatography device); 6 is a rubber gasket.

### DETAILED DESCRIPTION

The invention is described in detail hereinunder. In this description, the numerical range expressed by the wording “a number to another number” means the range that falls between the former number indicating the lowermost limit of the range and the latter number indicating the uppermost limit thereof. The proton-conductive material of the invention is meant to include ion exchanger (and also ion-exchange membrane), proton conductor (and also proton-conductive membrane).

The proton-conductive material of the invention has a structure where both an organic molecular chain containing a mesogen substituted with an electron-attracting group and a group containing a proton-donating group bond to a silicon-oxygen three-dimensional crosslinked matrix through a covalent bond. The material of the type can be formed, for example, through sol-gel reaction of an organosilicon compound precursor having a mesogen substituted with an electron-attracting group and a proton-donating group-containing precursor. These precursors and the method for producing a proton-conductive material from these precursors are described in detail hereinunder.

[1] Precursor:

[1-1] Organosilicon Compound Precursor Having a Mesogen Substituted With an Electron-Attracting Group:

The organosilicon compound precursor having a mesogen substituted with an electron-attracting group is preferably a compound of the following formula (1):
(Z¹)ₙ₁-A¹-[Si(OR¹)ₘ₁ (R²)₃₋ₘ₁]ₙ₂ (1)

In formula (1), R¹ represents an alkyl group or an aryl group, and m1 indicates an integer of from 1 to 3. Preferred examples of the alkyl group are linear, branched or cyclic alkyl groups (e.g., those having from 1 to 20 carbon atoms, such as methyl, ethyl, isopropyl, n-butyl, 2-ethylhexyl, n-decyl, cyclopropyl, cyclohexyl, cyclododecyl). Preferred examples of the aryl group are substituted or unsubstituted phenyl groups having from 6 to 20 carbon atoms, and substituted or unsubstituted naphthyl groups having from 10 to 20 carbon atoms. R² represents an alkyl group, an aryl group, or a heterocyclic group. Preferred examples of the alkyl group and the aryl group may be the same as those mentioned above for the alkyl group and the aryl group for R¹, and concrete examples thereof may also be the same as the latter. Preferred examples of the heterocyclic group are substituted or unsubstituted 6-membered heterocyclic groups (e.g., pyridyl, morpholino), and substituted or unsubstituted 5-membered heterocyclic groups (e.g., furyl, thiophenyl). Especially preferred are a methyl group, an ethyl group and a phenyl group.

n2 indicates an integer of from 1 to 3, and is preferably 1.

Z¹ represents a substituent capable of forming a carbon-carbon bond or a carbon-oxygen bond through polymerization, and its preferred examples are ethylenic unsaturated residue-having acryloyl, methacryloyl, vinyl and ethynyl groups, and cyclic alkyleneoxide groups such as epoxy group and oxetanyl group. More preferred are an acryloyl group, a methacryloyl group, and a cyclic alkyleneoxide group.

n1 indicates an integer of from 0 to 3, and is preferably from 1 to 3, more preferably 1.

A¹ represents an organic group containing a mesogen substituted with at least one electron-attracting group. The electron-attracting group is preferably a substituent having a Hammett's σp value of not lower than 0. The Hammett's σp value is described in Chemical Review, Vol. 91, No. 2 (1991), pp. 165-195. More preferably, the group is F (0.06), Cl (0.23), Br (0.39), I (0.18), CN (0.66), NO₂ (0.78), —COCH₃ (0.50), —CₙF₂ₙ₊₁ (where n indicates an integer of from 1 to 4) (about 0.5), SO₃⁻ (0.35), (e.g., SO₃H, SO₃Na and SO₃K); even more preferably A¹ is an organic group containing a mesogen of any of formulae (A-1) to (A-5) mentioned below; E represents an electron-attracting group (preferably any of the above-mentioned electron-attracting groups), r indicates an integer of 1 or more (more preferably an integer of 4 or more, even more preferably all hydrogens are substituted).

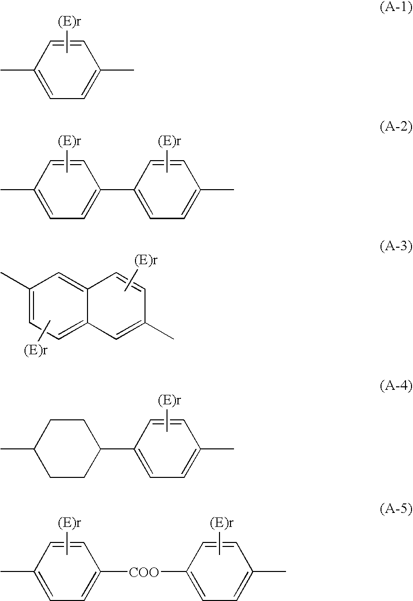

More preferably, A1 is represented by the following formula (2):
-[Q¹¹Y¹¹-Q¹²]ₘ₉- (2)

In formula (2), Q¹¹ and Q¹² each represent a divalent linking group or a single bond. The divalent linking group is preferably —CH=CH—, —CH═N—, —N═N—, —N(O)═N—, —COO—, —COS—, —CONH—, —COCH₂—, —CH₂CH₂—, —OCH₂—, —CH₂NH—, —CH₂—, —CO—, —O—, —S—, —NH—, —(CH₂)₍1 to 3)—, —CH═CH—COO—, —CH═CH—CO—, —(C≡C)₍1 to ₃)—, or their combination, more preferably —CH₂—, —CO—, —O—, —CH═CH—, —CH═N—, —N═N—, or their combination. These divalent linking groups may be substituted with any other substituent.

When n1 in formula (1) is 0, then any one of Q¹¹ and Q¹² represents a hydrogen atom, an alkyl group, an aryl group a halogen atom (e.g., F, Cl, Br, I), —CN, —NO₂, —COCH₃, —CₙF₂ₙ₊₁ (where n is an integer of from 1 to 4), SO₃H or [Si(OR¹)ₘ₁(R²)₃₋ₘ₁]ₙ₂. Preferred examples of the alkyl group are linear, branched or cyclic alkyl groups (e.g., those having from 1 to20 carbon atoms, such as methyl, ethyl, isopropyl, cyclohexyl). Preferred examples of the aryl group are substituted or unsubstituted phenyl groups having from 6 to 20 carbon atoms, and substituted or unsubstituted naphthyl groups having from 10 to 20 carbon atoms. Especially preferred are a methyl group, an ethyl group, a phenyl group a halogen atom (F, Cl, Br, I), —CN, —NO₂, —COCH₃, —CₙF₂ₙ₊₁ (where n is an integer of from 1 to 4), SO₃H, and [Si(OR¹)ₘ₁(R²)₃₋ₘ₁]ₙ₂; most preferred are a methyl group, F, Cl, CN, SO₃H, and [Si(OR)ₘ₁(R²)₃₋ₘ₁]ₙ₂.

Y¹¹ has a structure of any of (A-1) to (A-5); and m9 indicates an integer of from 1 to 3.

Preferably, the organosilicon compound of formula (1) has an alkyl or alkylene group having at least 5 carbon atoms, along with the mesogen therein for enhancing the molecular orientation of the compound. Preferably, the alkyl or alkylene group has from 5 to 25 carbon atoms, more preferably from 6 to 18 carbon atoms, even more preferably from 6 to 8 carbon atoms. The alkyl or alkylene group may be substituted. Preferred examples of the substituent are mentioned below.

1. Alkyl Group:

The alkyl group may be optionally substituted, and is more preferably an alkyl group having from 1 to 24 carbon atoms, even more preferably from 1 to 10 carbon atoms. It maybe linear or branched. For example, it includes methyl, ethyl, propyl, butyl, i-propyl, i-butyl, pentyl, hexyl, octyl, 2-ethylhexyl, t-octyl, decyl, dodecyl, tetradecyl, 2-hexyldecyl, hexadecyl, octadecyl, cyclohexylmethyl and octylcyclohexyl groups.

2. Aryl Group:

The aryl group maybe optionally substituted and condensed, and is more preferably an aryl group having from 6 to 24 carbon atoms. For example, it includes phenyl, 4-methylphenyl, 3-cyanophenyl, 2-chlorophenyl and 2-naphthyl groups.

3. Heterocyclic Group:

The heterocyclic group maybe optionally substituted and condensed. When it is a nitrogen-containing heterocyclic group, the nitrogen atom in the ring thereof may be optionally quaternated. More preferably, the heterocyclic group has from 2 to 24 carbon atoms. For example, it includes 4-pyridyl, 2-pyridyl, 1-octylpyridinium-4-yl, 2-pyrimidyl, 2-imidazolyl and 2-thiazolyl groups.

4. Alkoxy Group:

More preferably, the alkoxy group has from 1 to 24 carbon atoms. For example, it includes methoxy, ethoxy, butoxy, octyloxy, methoxyethoxy, methoxypenta(ethyloxy), acryloyloxyethoxy and pentafluoropropoxy groups.

5. Acyloxy Group:

More preferably, the acyloxy group has from 1 to 24 carbon atoms. For example, it includes acetyloxy and benzoyloxy groups.

6. Alkoxycarbonyl Group:

More preferably, the alkoxycarbonyl group has from 2 to 24 carbon atoms. For example, it includes methoxycarbonyl and ethoxycarbonyl groups.

7. Carbamoyloxy Group:

For example, this includes N,N-dimethylcarbamoyloxy, N,N-diethylcarbamoyloxy, morpholinocarbonyloxy, N,N-di-n-octylaminocarbonyloxy and N-n-octylcarbamoyloxy groups.

8. Alkoxycarbonyloxy Group:

For example, this includes methoxycarbonyloxy, ethoxycarbonyloxy, t-butoxycarbonyloxy and n-octylcarbonyloxy groups.

9. Aryloxycarbonyloxy Group:

For example, this includes phenoxycarbonyloxy, p-methoxyphenoxycarbonyloxy and p-n-hexadecyloxyphenoxycarbonyloxy groups.

10. Amino Group:

For example, this includes amino, methylamino, dimethylamino, anilino, N-methyl-anilino and diphenylamino groups.

11. Acylamino Group:

For example, this includes formylamino, acetylamino, pivaloylamino, lauroylamino, benzoylamino and 3,4,5-tri-n-octyloxyphenylcarbonylamino groups.

12. Aminocarbonylamino Group:

For example, this includes carbamoylamino, N,N-dimethylaminocarbonylamino, N,N-diethylaminocarbonylamino and morpholinocarbonylamino groups.

13. Alkoxycarbonylamino Group:

For example, this includes methoxycarbonylamino, ethoxycarbonylamino, t-butoxycarbonylamino, n-octadecyloxycarbonylamino and N-methyl-methoxycarbonylamino groups.

14. Aryloxycarbonylamino Group:

For example, this includes phenoxycarbonylamino, p-chlorophenoxycarbonylamino and m-n-octyloxyphenoxycarbonylamino groups.

15. Sulfamoylamino Group:

For example, this includes sulfamoylamino, N,N-dimethylaminosulfonylamino and N-n-octylaminosulfonylamino groups.

16. Alkyl and arylsulfonylamino Groups:

For example, these include methylsulfonylamino, butylsulfonylamino, phenylsulfonylamino, 2,3,5-trichlorophenylsulfonylamino and p-methylphenylsulfonylamino groups.

17. Sulfamoyl Group:

For example, this includes N-ethylsulfamoyl, N-(3-dodecyloxypropyl)sulfamoyl, N,N-dimethylsulfamoyl, N-acetylsulfamoyl, N-benzoylsulfamoyl and N-(N′-phenylcarbamoyl)sulfamoyl groups.

18. Alkyl and Arylsulfinyl Groups:

For example, these include methylsulfinyl, ethylsulfinyl, phenylsulfinyl and p-methylphenylsulfinyl groups.

19. Alkyl and Arylsulfonyl Groups:

For example, these include methylsulfonyl, ethylsulfonyl, phenylsulfonyl and p-methylphenylsulfonyl groups.

20. Acyl Group:

For example, this includes acetyl, pivaloyl, 2-chloroacetyl, stearoyl, benzoyl and p-n-octyloxyphenylcarbonyl groups.

21. Aryloxycarbonyl Group:

For example, this includes phenoxycarbonyl, o-chlorophenoxycarbonyl, m-nitrophenoxycarbonyl and p-t-butylphenoxycarbonyl groups.

22. Carbamoyl Group:

For example, this includes carbamoyl, N-methylcarbamoyl, N,N-dimethylcarbamoyl, N,N-di-n-octylcarbamoyl and N-(methylsulfonyl)carbamoyl groups.

23. Silyl Group:

Preferably, this has from3 to 30 carbon atoms, including, for example, trimethylsilyl, t-butyldimethylsilyl, phenyldimethylsilyl, trimethoxysilyl, triethoxysilyl, dimethoxymethylsilyl, diethoxymethylsilyl and triacetoxysilyl groups.

24. Cyano Group.

25. Fluoro Group.

26. Mercapto Group.

27. Hydroxyl Group.

When formula (1) has a mesogen and an alkyl or alkylene group, it is desirable that these bond to each other via a divalent linking group described hereinabove for Q¹¹ in formula (2).

Specific examples of the compounds of formula (1) for use in the invention are described below, to which, however, the invention should not be limited.

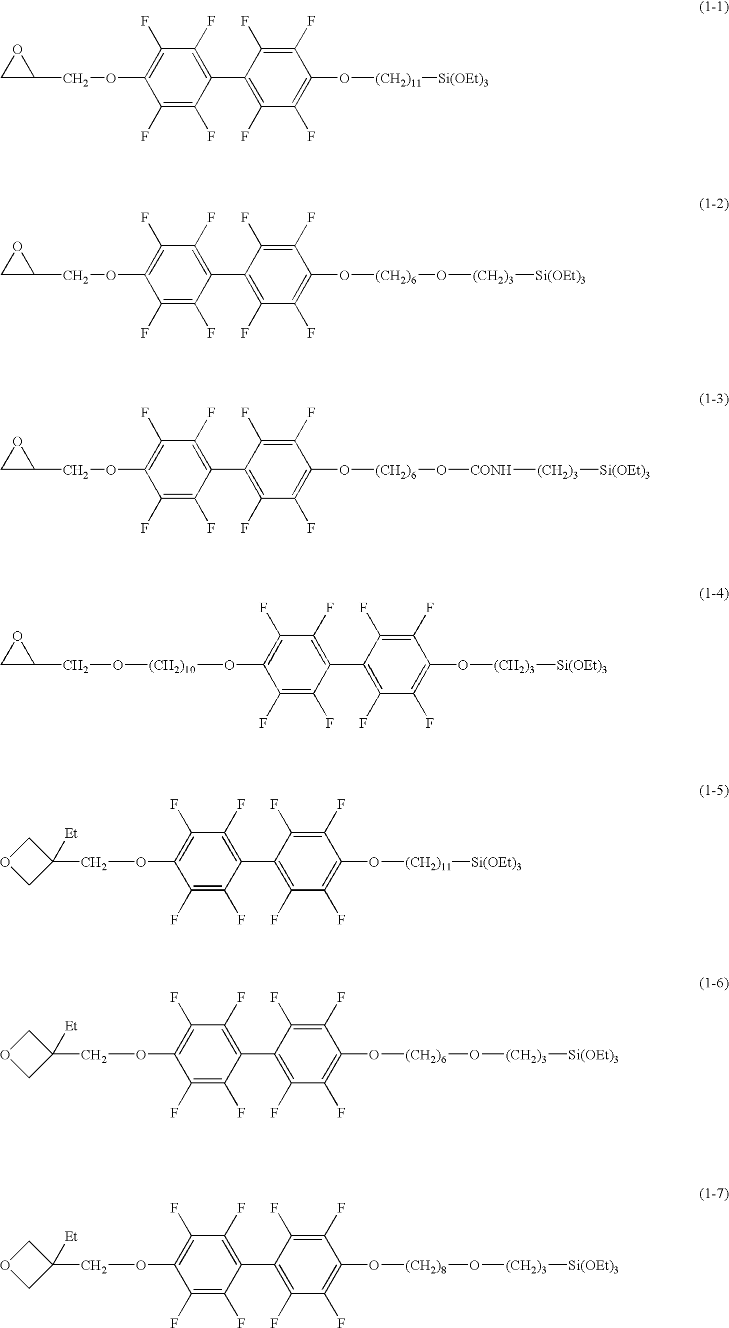

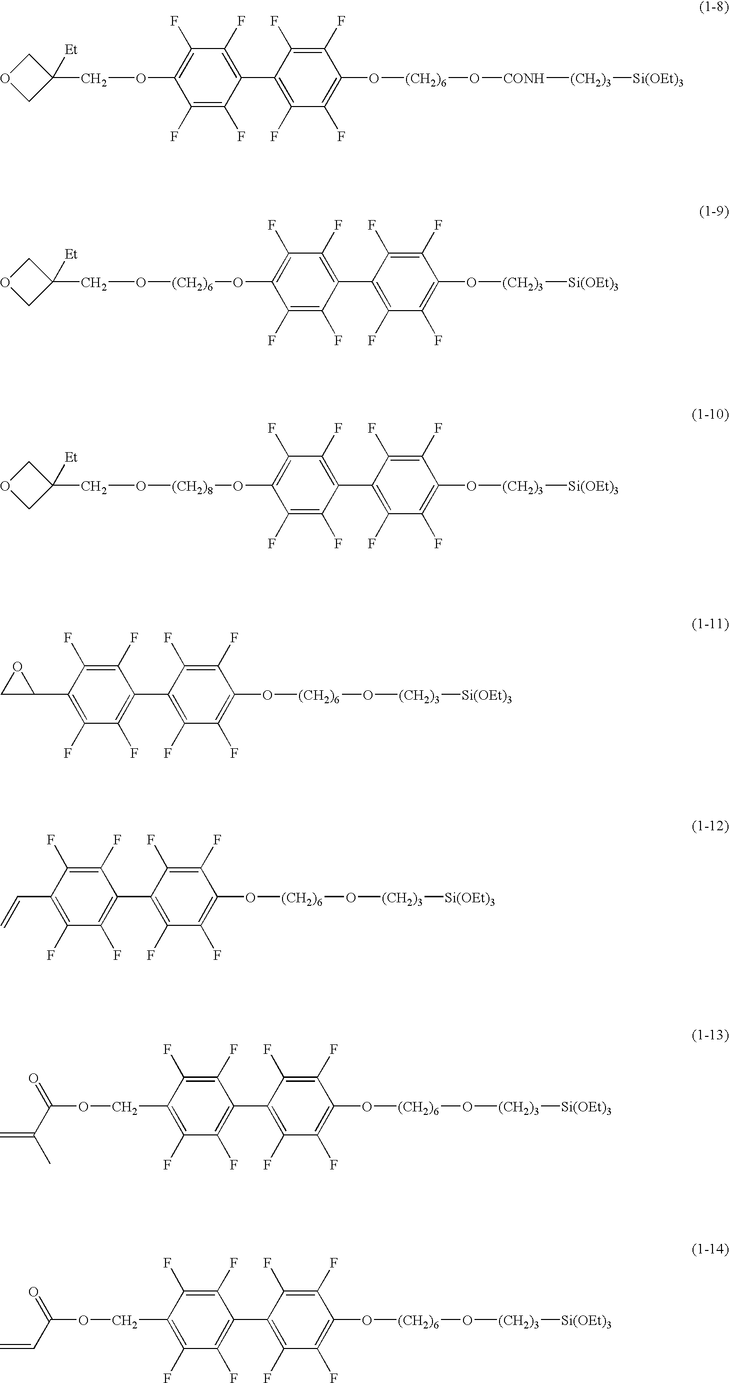

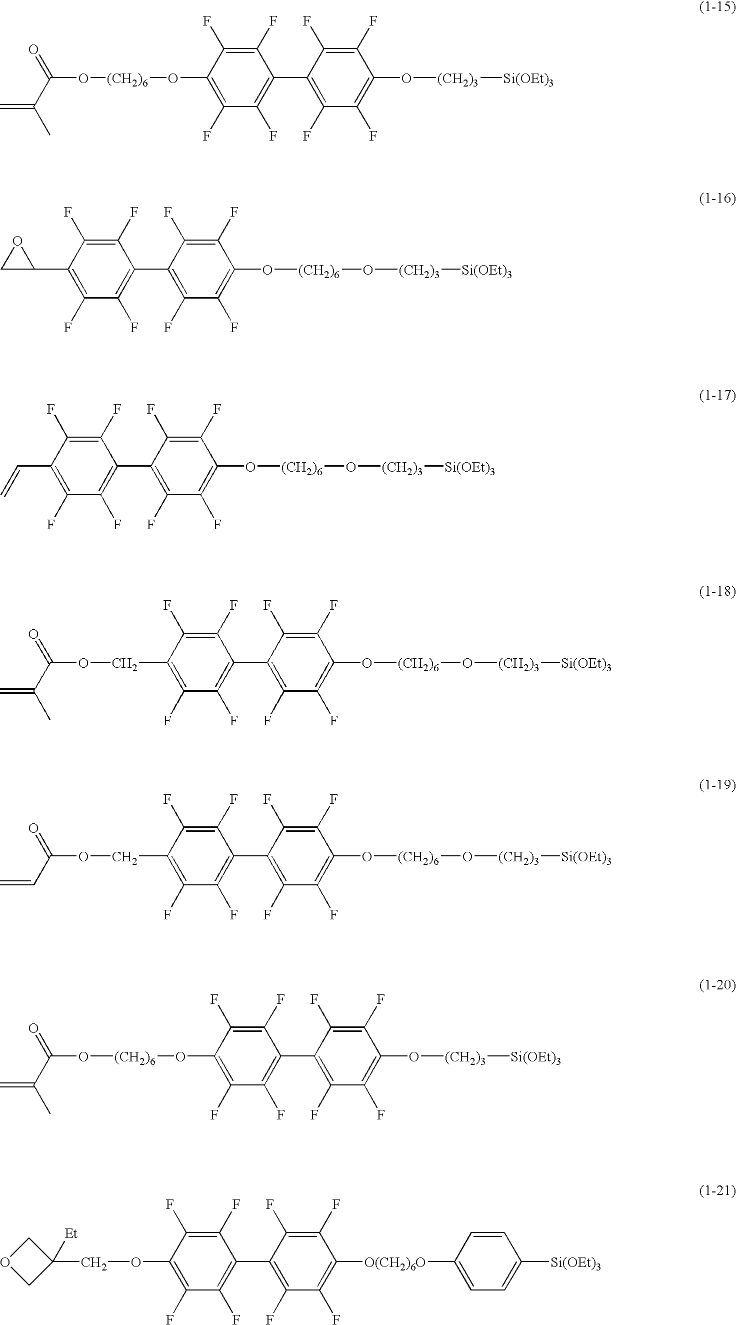

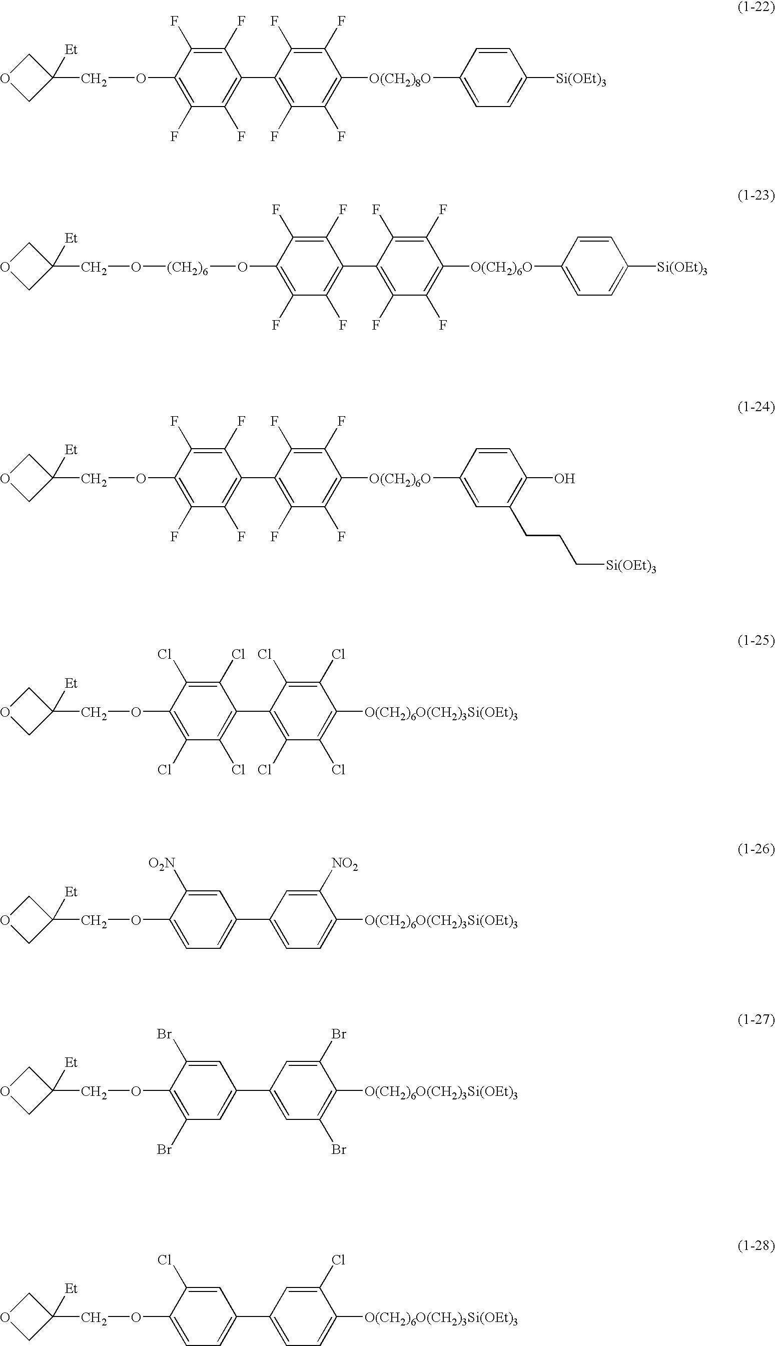

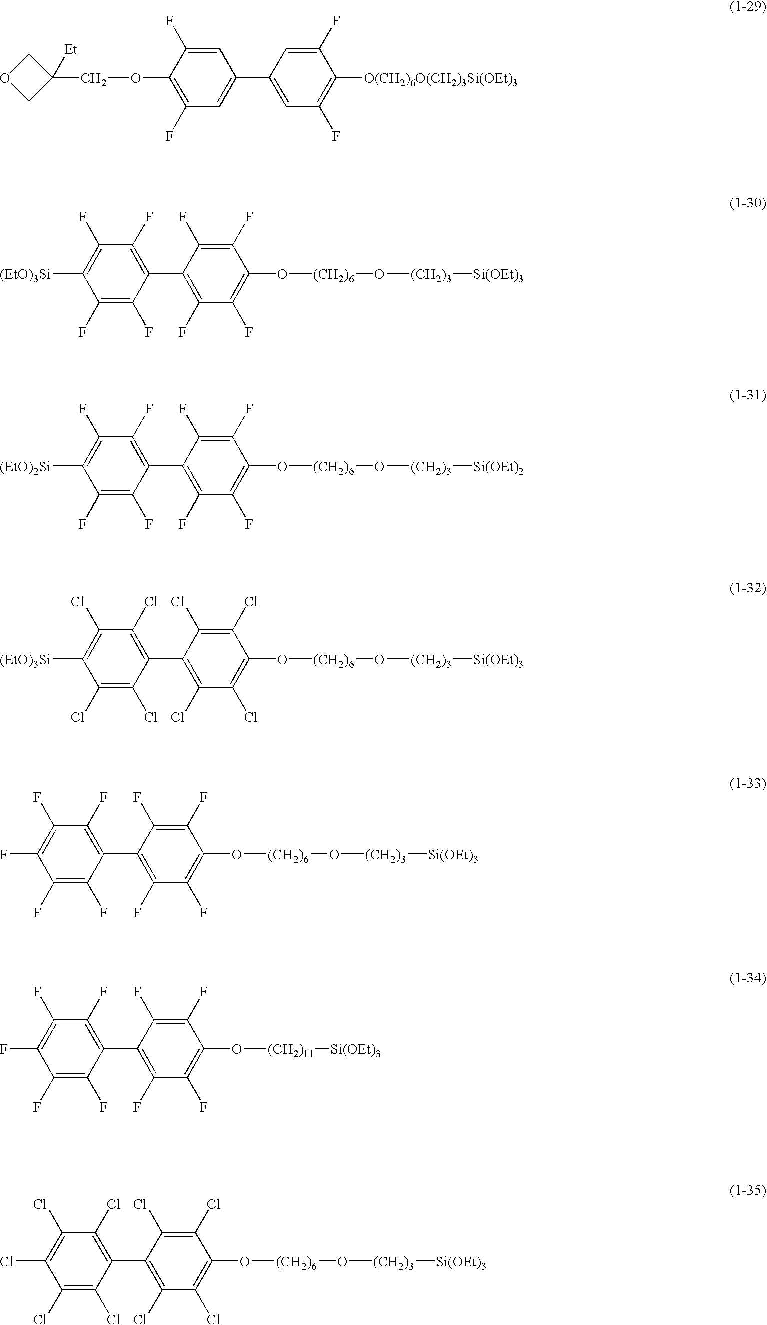

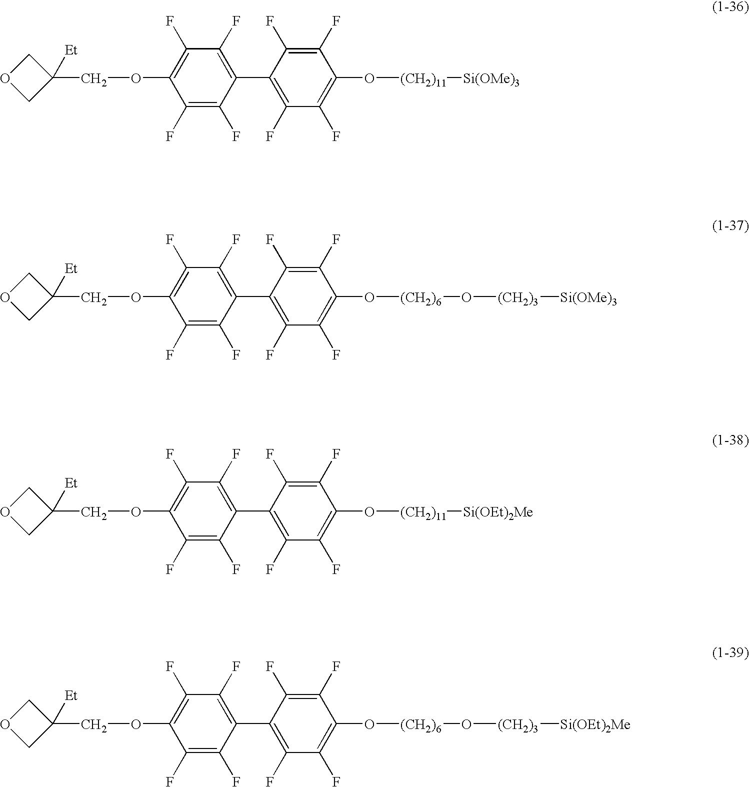

Using the compound of formula (1) gives a proton-conductive material having an organic molecular chain that contains a mesogen substituted with an electron-attracting group, for example, having a moiety of the following formula (1-1):

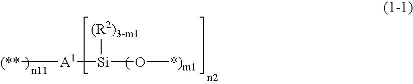

In formula (1-1), A¹ represents an organic group containing a mesogen substituted with at least one electron-attracting group; R² represents an alkyl group, an aryl group or a heterocyclic group; m1 indicates an integer of from 1 to 3; n2 indicates an integer of from 1 to 3; when the formula has two or more R²'s, then they may be the same or different; nil indicates an integer of from 0 to 3; * indicates the position at which the oxygen atom bonds to the silicon atom of the compound; and ** indicates the position at which A¹ bonds to the organic polymer chain of the compound.

In this, A¹, R², m1 and n2 are the same as those in formula (1), and their preferred ranges are also the same as the latter. n11 is preferably 1.

[1-2] Proton-Donating Group-Containing Precursor:

The proton-donating group-containing precursor in the invention is preferably a silicon compound of the following formula (3):
L-(S)ₚ-B-[Si(OR³)₃₋ₘ₂(R⁴)ₘ₂]ₙ₂ (3)

In formula (3), B represents an organic group containing an aliphatic group and/or an aromatic group. Its examples are an alkylene group (preferably having from 1 to 12 carbon atoms), a phenylene group and their combination. Optionally, it may contain a divalent linking group such as that described hereinabove for Q¹¹ in formula (2), and may have a substituent. R³ and R⁴ have the same meanings as R¹ and R² in formula (1). m2 indicates an integer of from 1 to 3; n2 indicates an integer of from 1 to 4; p indicates an integer of from 1 to 5; when p is 1, then L represents a hydrogen atom or —COCH₃, and when p is an integer of from 2 to 5, then L represents an alkyl group, an aryl group, a heterocyclic group, or [Si(OR³)₃₋ₘ₂(R⁴)ₘ₂]ₙ₂. Preferred examples of the alkyl group are methyl, ethyl, isopropyl, n-butyl, 2-ethylhexyl and cyclododecyl group; preferred examples of the hetero ring are substituted or unsubstituted 6-membered hetero rings (e.g., pyridyl, morpholino), and substituted or unsubstituted 5-membered hetero rings (e.g., furyl, thiophenyl). Especially preferred are a methyl group, an ethyl group and a phenyl group. When the formula has two or more R³'s and R⁴'s, then they may be the same or different.

The proton-donating group-containing silicon compound readily condenses with the acid of itself to gel. Therefore, it is desirable that a solution of an oxide of an —(S)p-L group-containing compound is used as the precursor sol for forming the proton-conductive membrane of the invention. The group —(S)p-L can be converted into a sulfo group through oxidization with an oxidizing agent. Examples of the oxidizing agent to be used for the reaction are, as oxidizable oxidizing agents, sulfur compounds described in Lecture of Experimental Science (by Maruzen). Concretely, examples of the oxidizing agent are halides such as iodides, bromides; organic peracids such as peracetic acid, 3-chloro-perbenzoic acid, mono-perphthalic acid; and hydrogen peroxide, potassium permanganate. Preferred are water-soluble oxidizing agents such as hydrogen peroxide and peracetic acid.

Specific examples of the compounds of formula (3) are mentioned below, to which, however, the invention should not be limited.

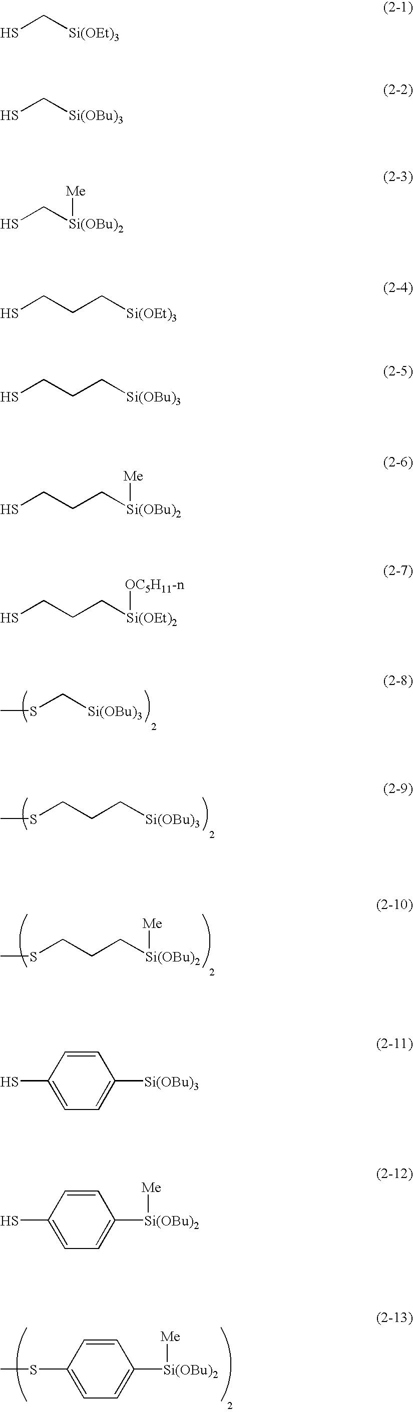

Using the compound of formula (3) gives a proton-conductive material that has a proton-donating group-containing group, for example, having a moiety of the following formula (3-1): 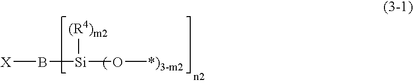
wherein X represents a proton-donating group and is preferably a sulfonic acid group; B represents an organic group containing an aliphatic group and/or an aromatic group; R⁴ represents an alkyl group, an aryl group or a heterocyclic group; m2 indicates an integer of from 1 to 3; n2 indicates an integer of from 1 to 4; * indicates the position at which the oxygen atom bonds to the silicon atom of the compound; and when the formula has two or more R⁴'s, then they may be the same or different.

In this, B, R⁴, m2 and n2 have the same meanings as those in formula (3), and their preferred ranges are also the same as the latter.

[2] Method of Forming Proton-Conductive Material:

[2-1] Sol-Gel Process:

In the invention, generally employed is a sol-gel process that comprises metal alkoxide hydrolysis, condensation and drying (optionally firing) to give a solid. For example, herein employable are the methods described in JP-A2000-272932, 2000-256007, 2000-357524, 2001-307752, and Electrochimica Acta, 1998, Vol. 43, Nos. 10-11, p. 1301. An acid catalyst is generally used for condensation. However, in the invention, the precursor described in [1-2] may serve as a acid catalyst by itself, and the reaction does not require any additional acid to be added thereto.

One typical method of forming the proton-conductive material of the invention comprises dissolving a compound of formula (3) in a solvent (e.g., methanol, ethanol, isopropanol), and adding an oxidizing agent to the resulting solution to thereby convert the group —(S)p-L in the compound into —SO₃H. The sol, thus obtained, is mixed with an organosilicon compound (1) described in [1-1] to attain the hydrolysis and polycondensation of the alkoxysilyl group in the compound (this is hereinafter referred to as “sol-gel reaction”). Alternatively, a compound of formula (3) and an organosilicon compound (1) described in [1-1] are dissolved in any desired solvent (e.g., methanol, ethanol, isopropanol), and then an oxidizing agent is added to it, thereby converting the group —(S)p-L in the compound into —SO₃H followed by sol-gel reaction of the compounds. Through the process, formed is a silicon-oxygen three-dimensional crosslinked matrix.

If desired, the reaction system may be heated. The viscosity of the reaction mixture (sol) gradually increases, and after the solvent is evaporated away and the remaining sol is dried, then a solid (gel) is obtained. While fluid, the sol may be cast into a desired vessel or applied onto a substrate, and thereafter the solvent is evaporated away and the remaining sol is dried to give a solid membrane. For further densifying the silica network formed therein, the membrane may be optionally heated after dried.

The solvent for the sol-gel reaction is not specifically defined so far as it dissolves the organosilicon compound precursor. For it, however, preferred are carbonate compounds (e.g., ethylene carbonate, propylene carbonate), heterocyclic compounds (e.g., 3-methyl-2-oxazolidinone, N-methylpyrrolidone), cyclic ethers (e.g., dioxane, tetrahydrofuran), linear ethers (e.g., diethyl ether, ethylene glycol dialkyl ether, propylene glycol dialkyl ether, polyethylene glycol dialkyl ether, polypropylene glycol dialkyl ether), alcohols (e.g., methanol, ethanol, isopropanol, ethylene glycol monoalkyl ether, propylene glycolmonoalkyl ether, polyethylene glycol monoalkyl ether, polypropylene glycol monoalkyl ether), polyalcohols (e.g., ethylene glycol, propylene glycol, polyethylene glycol, polypropylene glycol, glycerin), nitrile compounds (e.g., acetonitrile, glutarodinitrile, methoxyacetonitrile, propionitrile, benzonitrile), esters (e.g., carboxylates, phosphates, phosphonates), aprotic polar substances (e.g., dimethylsulfoxide, sulforane, dimethylformamide, dimethylacetamide), non-polar solvents (e.g., toluene, xylene), chlorine-containing solvents (e.g., methylene chloride, ethylene chloride), water, etc. Above all, especially preferred are alcohols such as ethanol, isopropanol, fluoroalcohols; nitrile compounds such as acetonitrile, glutarodinitrile, methoxyacetonitrile, propionitrile, benzonitrile; and cyclic ethers such as dioxane, tetrahydrofuran. One or more of these may be used herein either singly or as combined. For controlling the drying speed, a solvent having a boiling point of not lower than 100° C., such as N-methylpyrrolidone, dimethylacetamide, sulforane or dioxane, maybe added to the above-mentioned solvent. The total amount of the solvent is preferably from 0.1 to 100 g, more preferably from 1 to 10 g, per gram of the precursor compound.

For promoting the sol-gel reaction, an acid catalyst may be used. Preferably, the acid catalyst is an inorganic or organic proton acid. The inorganic proton acid includes, for example, hydrochloric acid, sulfuric acid, phosphoric acids (e.g., H₃PO₄, H₃PO₃, H₄P₂O₇, H₅P₃O₁₀, metaphosphoric acid, hexafluorophosphoric acid), boric acid, nitric acid, perchloric acid, tetrafluoroboric acid, hexafluoroarsenic acid, hydrobromic acid, solid acids (e.g., tungstophosphoric acid, tungsten-peroxo complex). For the organic proton acid, for example, usable are low-molecular compounds such as phosphates (for example, those with from 1 to 30 carbon atoms, such as methyl phosphate, propyl phosphate, dodecyl phosphate, phenyl phosphate, dimethyl phosphate, didodecyl phosphate), phosphites (for example, those with from 1 to 30 carbon atoms, such as methyl phosphite, dodecyl phosphite, diethyl phosphite, diisopropyl phosphite, didodecyl phosphite), sulfonic acids (for example, those with from 1 to 15 carbon atoms, such as benzenesulfonic acid, toluenesulfonic acid, hexafluorobenzenesulfonic acid, trifluoromethanesulfonic acid, dodecylsulfonic acid), carboxylic acids (for example, those with from 1 to 15 carbon atoms, such as acetic acid, trifluoroacetic acid, benzoic acid, substituted benzoic acids), imides (e.g., bis(trifluoromethanesulfonyl)imido acid, trifluoromethanesulfonyltrifluoroacetamide), phosphonic acids (for example, those with from 1 to 30 carbon atoms, such as methylphosphonic acid, ethylphosphonic acid, phenylphosphonic acid, diphenylphosphonic acid, 1,5-naphthalenebisphosphonic acid); and proton acid segment-having high-molecular compounds, for example, perfluorocarbonsulfonic acid polymers such as typically Nafion®, and sulfonated, heat-resistant aromatic polymers such as sulfonated polyether-ether ketones (JP-A6-93111), sulfonated polyether sulfones (JP-A10-45913), sulfonated polysulfones (JP-A9-245818). Two or more of these may be used herein, as combined.

The reaction temperature in the sol-gel reaction is associated with the reaction speed, and it may be suitably determined depending on the reactivity of the precursor to be reacted and on the type and the amount of the acid selected for the reaction. Preferably, it falls between −20 and 150° C., more preferably between 0 and 80° C., even more preferably between 20 and 60° C.

[2-2] Polymerization of Polymerizing Group Z¹:

When the polymerizing group Z¹ is a carbon-carbon unsaturated bond-having group, for example, a (meth)acryloyl, vinyl or ethynyl group, then radical polymerization for ordinary polymer production may apply to the case. The process is described in Takayuki Ohtsu & Masaetsu Kinoshita, Experimental Process for Polymer Production (by Kagaku Dojin), and Takayuki Ohtsu, Lecture of Polymerization Theory 1, Radical Polymerization (1) (by Kagaku Dojin).

The radical polymerization includes thermal polymerization with a thermal polymerization initiator and photopolymerization with a photopolymerization initiator. Preferred examples of the thermal polymerization initiator are azo-type initiators such as 2,2′-azobis(isobutyronitrile), 2,2′-azobis(2,4-dimethylvaleronitrile), dimethyl 2,2′-azobis (2-methylpropionate); and peroxide-type initiators such as benzoyl peroxide. Preferred examples of the photopolymerization initiator are a-carbonyl compounds (U.S. Pat. Nos. 2,367,661 and 2,367,670), acyloin ethers (U.S. Pat. No. 244,828), α-hydrocarbon-substituted aromatic acyloin compounds (U.S. Pat. No. 2,722,512), polynuclear quinone compounds (U.S. Pat. Nos. 3,046,127 and 2,951,758), combinations of triarylimidazole dimer and p-aminophenyl ketone (U.S. Pat. No. 35,493,676), acridine and phenazine compounds (JP-A 60-105667, U.S. Pat. No. 4,239,850), and oxadiazole compounds (U.S. Pat. No. 4,212,970).

The polymerization initiator may be added to the reaction system before the start of the sol-gel reaction in the above [2-1], or may be added to the reaction product after the sol-gel reaction and immediately before the application of the reaction product to substrates. Preferably, the amount of the polymerization initiator to be added is from 0.01 to 20% by mass, more preferably from 0.1 to 10% by mass relative to the total amount of the monomers.

When the polymerizing group Z¹ is an alkylene oxide group such as ethylene oxide or trimethylene oxide, then the polymerization catalyst to be used in the case is preferably a proton acid (as in the above [2-1]), or a Lewis acid (preferably, boron trifluoride (including its ether complex), zinc chloride, aluminium chloride). In case where the proton acid used in the sol-gel reaction serves also as the polymerization catalyst, then it does not require any additional proton acid specifically for the polymerization of the polymerizing group Z¹. When used, the polymerization catalyst is preferably added to the reaction product just before the product is applied to substrates. In general, the polymerization is promoted in the membrane being formed on substrates through exposure of the membrane to heat or light. With that, the molecular orientation in the membrane is fixed and the membrane strength is thereby enhanced.

[2-3] Combination With Other Silicon Compound:

If desired, two or more precursors described in the above [1-1] and [1-2] maybe mixed for use herein for improving the properties of the membranes formed. For example, a compound of formula (1) where m1 is 3 and a compound of the same formula where m1 is 2 may be mixed, and/or a compound of formula (2) where m2 is 3 may be mixed with a compound of the same formula where m2 is 2, whereby more flexible membranes may be produced. Optionally, any other silicon compound may be further added to these precursors. Examples of the additional silicon compound are organosilicon compounds of the following formula (4), and their polymers.
(R⁷)ₘ₄—Si—(OR⁸)₄₋ₘ₄ (4)
wherein R⁷ represents a substituted or unsubstituted alkyl, aryl or heterocyclic group; R⁸ represents a hydrogen atom, an alkyl group, an aryl group, or a silyl group; m4 indicates an integer of from 0 to 4; when the formula has 2 or more R⁷'s or R⁸'s, then they may be the same or different. The compounds of formula (4) may bond to each other at R⁷ or at the substituent on R⁷ to form polymers.

In formula (4), R⁷ and R⁸ have the same meanings as R¹ and R² in formula (1), and their preferred ranges are also the same as those of the latter.

In formula (4), m4 is preferably 0 or 1; R⁷is preferably an alkyl group or forms a vinyl polymer. When m4 is 0, preferred examples of the compound are tetramethoxysilane (TMOS) and tetraethoxysilane (TEOS) Examples of preferred compounds where m4 is 1 are mentioned below.

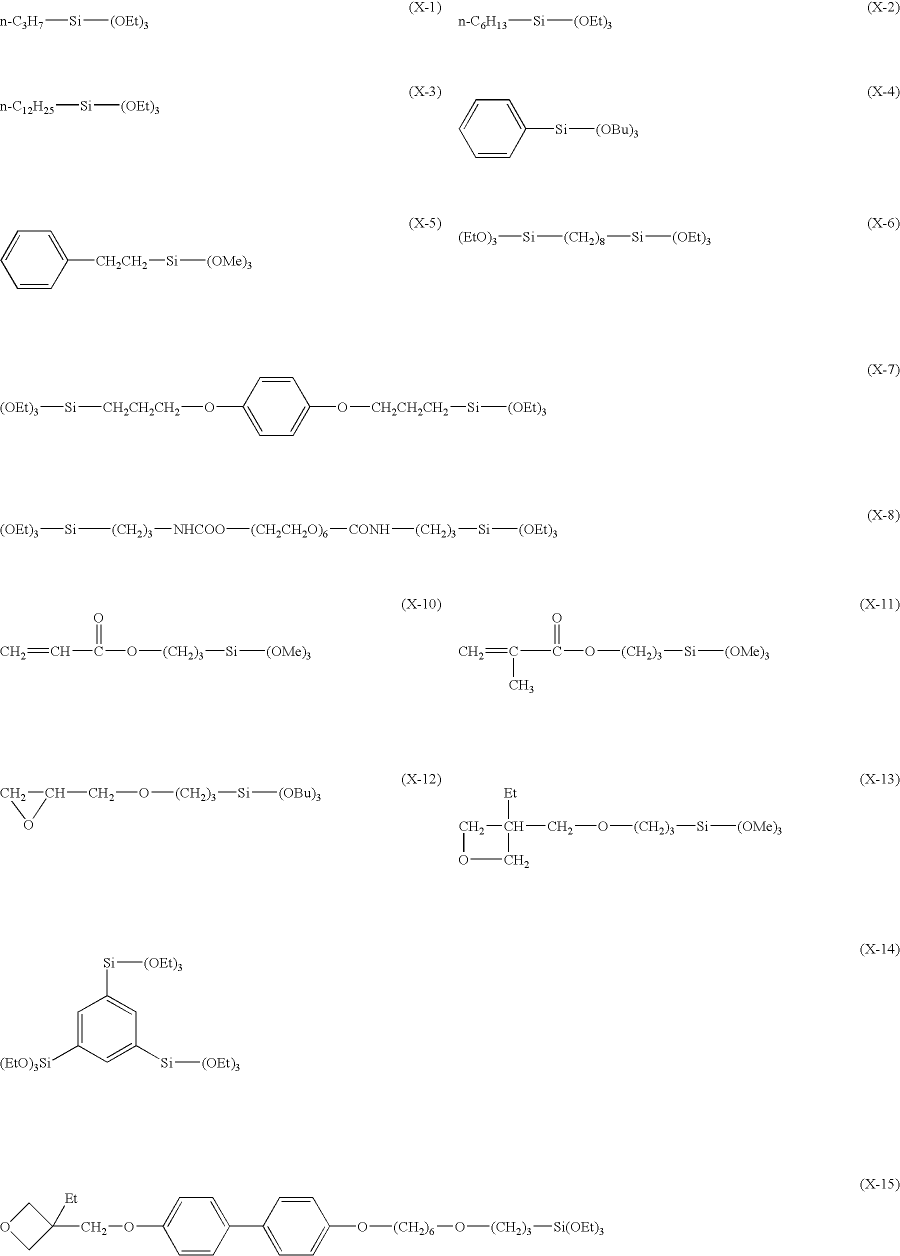

When the compound of formula (4) is combined with the organosilicon compound in the invention, then its amount is preferably from 1 to 50 mol %, more preferably from 1 to 20 mol % of the compound.

The sol-gel reaction of the silicon compound precursor in the invention goes on while the organic site of the compound is oriented after the sol-gel reaction mixture that contains the precursor is applied onto a substrate. To promote the orientation of the sol-gel composition, various methods may be employed. For example, supports such as those mentioned above may be previously oriented. The orientation may be effected in any ordinary method. Preferably, an orientable liquid-crystal layer of, for example, various orientable polyimide films or polyvinyl alcohol films is formed on a support, and rubbed for orientation; or the sol-gel composition applied on a support is put in a magnetic field or an electric field, or it is heated.

The orientation condition of the organic-inorganic hybrid solid material obtained in the invention may be confirmed through observation of the optical anisotropy of the material with a polarizing microscope. The orientation condition of the material of the invention is not specifically defined so far as it exhibits a phase generally recognizable as a liquid-crystal phase in the art of liquid crystals. Preferably, however, the material exhibits a nematic phase, a smectic A phase, a smectic C phase, a cholesteric phase, more preferably a smectic A phase at room temperature.

The thickness of the organic-inorganic hybrid proton-conductive membrane that is obtained by peeling it from a support is preferably from 10 to 500 μm, more preferably from 25 to 100 μm.

[2-4] Method of Film Formation:

The supports to which the sol-gel reaction mixture is applied in the invention are not specifically defined, and their preferred examples are glass substrates, metal substrates, polymer films and reflectors. Examples of the polymer films are cellulose polymer films of TAC (triacetyl cellulose), ester polymer films of PET (polyethylene terephthalate) or PEN (polyethylene naphthalate), fluoropolymer films of PTFE (polytrifluoroethylene), and polyimide films. Any known method of, for example, curtain coating, extrusion coating, roll coating, spin coating, dipping, bar coating, spraying, slide coating or printing is herein employable for applying the sol-gel reaction mixture to the supports.

[2-5] Filling to Porous Membrane:

The proton-conductive material of the invention may be infiltrated into the pores of a porous substrate to form a film. The sol-gel reaction solution of the invention is applied to a porous substrate so that it is infiltrated into the pores of the substrate, or such a porous substrate is dipped in the sol-gel reaction solution to thereby fill the pores with the proton-conductive material to form a film. Preferred examples of such a porous substrate are porous polypropylene, porous polytetrafluoroethylene, porous crosslinked heat-resistant polyethylene and porous polyimide films.

[2-8] Addition of Catalyst Metal to Proton-Conductive Material:

An active metal catalyst may be added to the proton-conductive material of the invention for promoting the redox reaction of anode fuel and cathode fuel. The fuel having penetrated into the proton-conductive material that contains the catalyst may be well consumed inside the proton-conductive material, not reaching any other electrode, and this is effective for preventing crossover. The active metal for the catalyst is not specifically defined provided that it functions as an electrode catalyst. For it, for example, suitable is platinum or platinum-based alloy.

The invention is described more concretely with reference to the following Examples. The materials, their amount and proportion, the processing modes and the processing orders may be varied and changed in any desired manner, not overstepping the scope and the sprit of the invention. Accordingly, the invention should not be limited to the following Examples.

### EXAMPLE 1-1

### Production of Silicon Compound

Production Examples for the compounds of formula (1) of the invention, Nos. 1-5, 1-6, 1-21, 1-25 to 1-29 are described below. 10 Processes for producing these compounds are shown as the following schemes 1 to 8.

(1) Production of 1-5 (Scheme 1):

(Scheme 1: Production of 1-5) 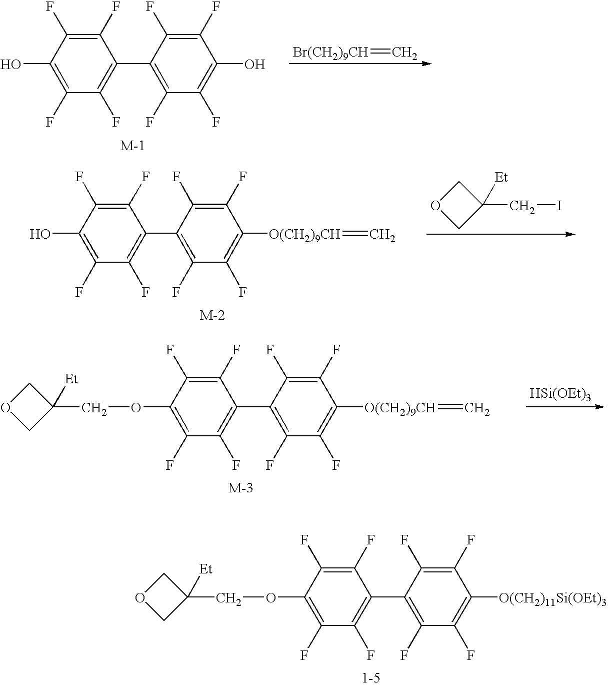
(1-1) Production of Intermediate M-2:

Octafluoro-4,4′-bisphenol (M-1, by Tokyo Kasei) (10.0 g, 30 mmol) was dissolved in 50 ml of DMF, to which was added 4.1 g of potassium carbonate. With stirring under heat at 80° C., 11-bromo-1-undecene (7.1 g, 30 mmol) was dropwise added to it, taking 10 minutes. This was stirred still under heat for 3 hours, and then the reaction mixture was poured into water, extracted with ethyl acetate and purified through column chromatography to obtain 7.4 g of M-2.

(1-2) Production of Intermediate M-3:

M-2 (7.2 g, 15 mmol) obtained in the above was dissolved in 50 ml of DMF, to which was added potassium carbonate (2.1 g, 15 mmol). With stirring under heat at 80° C., 3-ethyl-3-oxetanylmethyl iodide (3.41 g, 15 mmol) was dropwise added to it. This was stirred still under heat for 2 hours, and then the reaction mixture was poured into water, extracted with ethyl acetate and purified through column chromatography to obtain 7.4 g of M-3.

(1-3) Production of 1-5:

M-3 (5.8 g, 10 mmol) obtained in the above and triethoxysilane (2.0 g, 12 mmol) were dissolved in toluene, and the reactor was purged with nitrogen. The reaction solution was kept at 80° C., to which was added chloroplatinic acid (5 mg). This was then heated for 3 hours. The reaction mixture was concentrated and purified through silica gel column chromatography to obtain 4.5 g of the intended 1-5.
(2) Production of 1-6 (Scheme 2): 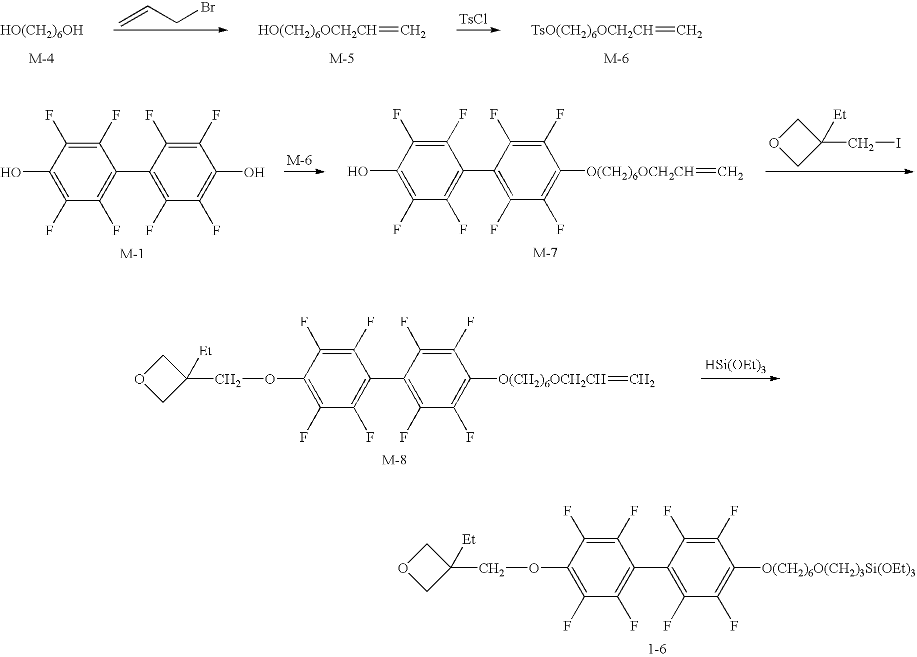
(2-1) Production of Intermediate M-5:

1.6-Hexanediol (M-4, by Tokyo Kasei) (59.1 g, 0.5 mol) was dissolved in 25 ml of THF, to which was added KOH (28.1 g, 0.5 mol). With stirring under heat at 80° C., allyl bromide (60.5 g, 0.5 mol) was dropwise added to it, taking 10 minutes. This was stirred still under heat for 1 hour, and then the reaction mixture was filtered, and the residue was concentrated and distilled under reduced pressure to obtain 38.0 g of the intended M-5.

(2-2) Production of Intermediate M-6:

M-5 (38.0 g, 0.24 mol) obtained in the above was dissolved in 100 ml of pyridine, to which was added p-toluenesulfonyl chloride (24,5 g, 105 mmol), and this was stirred under heat at 40° C. After stirred still under heat for 3 hours, the reaction mixture was poured into water, extracted with ethyl acetate and purified through column chromatography to obtain 24.7 g of the intended M-6.

(2-3) Production of Intermediate M-7:

Octafluoro-4,4′-bisphenol (M-1, by Tokyo Kasei) (15.4 g, 46.6 mmol) was dissolved in 75 ml of DMF, to which was added 6.4 g of potassium carbonate. With stirring under heat at 80° C., the intermediate M-6 (14.5 g, 46.6 mmol) was dropwise added to it, taking 10 minutes. This was stirred still under heat for 5 hours, and then the reaction mixture was poured into water, extracted with ethyl acetate and purified through column chromatography to obtain 8.8 g of the intended M-7.

(2-4) Production of Intermediate M-8:

M-7 (8.8 g, 18.7 mmol) obtained in the above was dissolved in 30 ml of DMF, to which was added potassium carbonate (2.63 g, 19.0 mmol). With stirring under heat at 80° C., 3-ethyl-3-oxetanylmethyl iodide (4.30 g, 19.0 mmol) was dropwise added to it. This was stirred still under heat for 2 hours, and then the reaction mixture was poured into water, extracted with ethyl acetate and purified through column chromatography to obtain 8.8 g of M-8.

(2-5) Production of 1-6:

M-8 (5.68 g, 10 mmol) obtained in the above and triethoxysilane (2.5 g, 15 mmol) were dissolved in toluene, and the reactor was purged with nitrogen. The reaction solution was kept at 80° C., to which was added chloroplatinic acid (5 mg). This was then heated for 3 hours. The reaction mixture was concentrated and purified through silica gel column chromatography to obtain 3.8 g of the intended 1-6.
(3) Production of 1-21 (scheme 3): 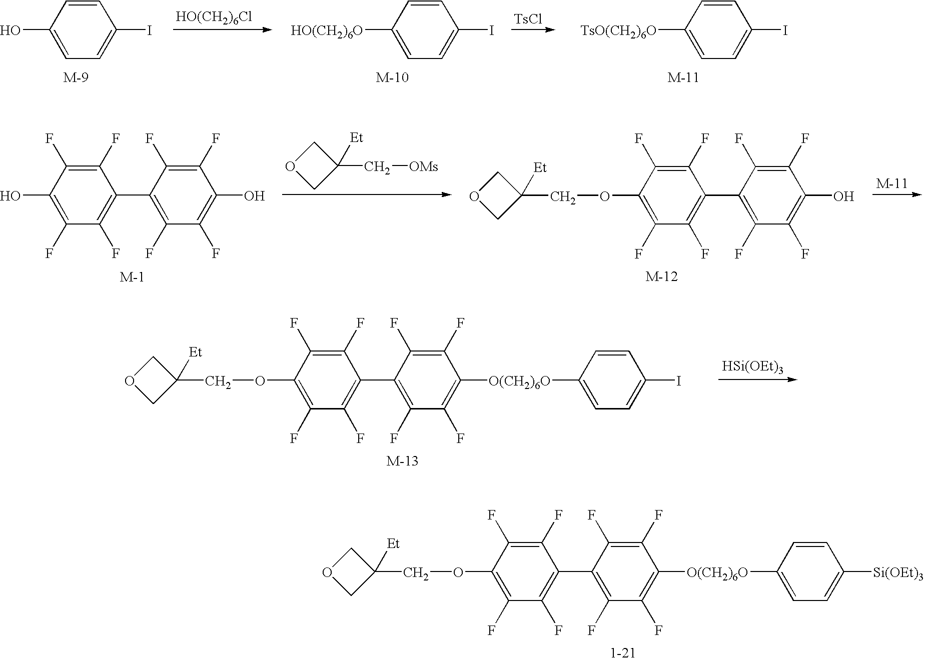
(3-1) Production of Intermediate M-10:

P-iodophenol M-9 (10.0 g, 45.5 mmol, by Tokyo Kasei) was dissolved in 50 ml of DMF, to which were added potassium carbonate (6.5 g) and potassium iodide (44.0 g). To this, 6-chlorohexanol (6.5 g, 47.6 mmol) was added. This was stirred under heat for 6 hours, and the reaction mixture was poured into water, extracted with ethyl acetate and purified through column chromatography to obtain 12.6 g of the intended M-10.

(3-2) Production of intermediate M-11:

M-10 (12.1 g, 37.8 mol) obtained in the above was dissolved in 15 ml of pyridine, to which was added p-toluenesulfonyl chloride (7.2 g, 37.8 mmol), and this was stirred at room temperature for 3 hours. The reaction mixture was poured into water, extracted with ethyl acetate and purified through column chromatography to obtain 12.2 g of the intended M-11.

(3-3) Production of Intermediate M-12:

Octafluoro-4,4′-bisphenol (M-1, by Tokyo Kasei) (25.6 g, 75.5 mmol) was dissolved in 150 ml of DMF, to which was added 10.7 g of potassium carbonate. With stirring under heat at 80° C., 3-ethyl-3-oxetanemethylmesylate (15.0 g, 77.2 mmol) was dropwise added to it, taking 10 minutes. After this was stirred still under heat for 5 hours, the reaction mixture was poured into water, and neutralized with concentrated hydrochloric acid. The resulting crystal was collected. Thus obtained, the crude crystal was recrystallized from acetonitrile to obtain 12.0 g of the intended M-12.

(3-4) Production of Intermediate M-13:

M-12 (8.5 g, 20 mmol) obtained in the above was dissolved in 10 ml of DMF, to which was added 3 g of potassium carbonate. With stirring under heat at 80° C., M-11 (9.5 g, 20 mmol) obtained in the above was dropwise added to it. This was stirred still under heat for 2 hours, and then the reaction mixture was poured into water, extracted with ethyl acetate and purified through column chromatography to obtain 12.0 g of the intended M-13.

(3-5) Production of 1-21:

(Bisbenzylideneacetone)palladium (0.166 g, 0.19 mmol, by Tokyo Kasei) and 2-(di-t-butylphosphino)biphenyl (0.173 g, 0.38 mmol, by STREM) were dissolved in N-methylpyrrolidone, to which were added M-13 (7.0 g, 6.3 mmol) obtained in the above, diisopropylethylamine (5.0 ml, 18.9 mmol) and triethoxysilane. This was stirred at room temperature for 2 hours, then extracted with hexane and purified through column chromatography to obtain 3.7 g of the intended 1-21.
(4) Production of 1-25 (Scheme 4): 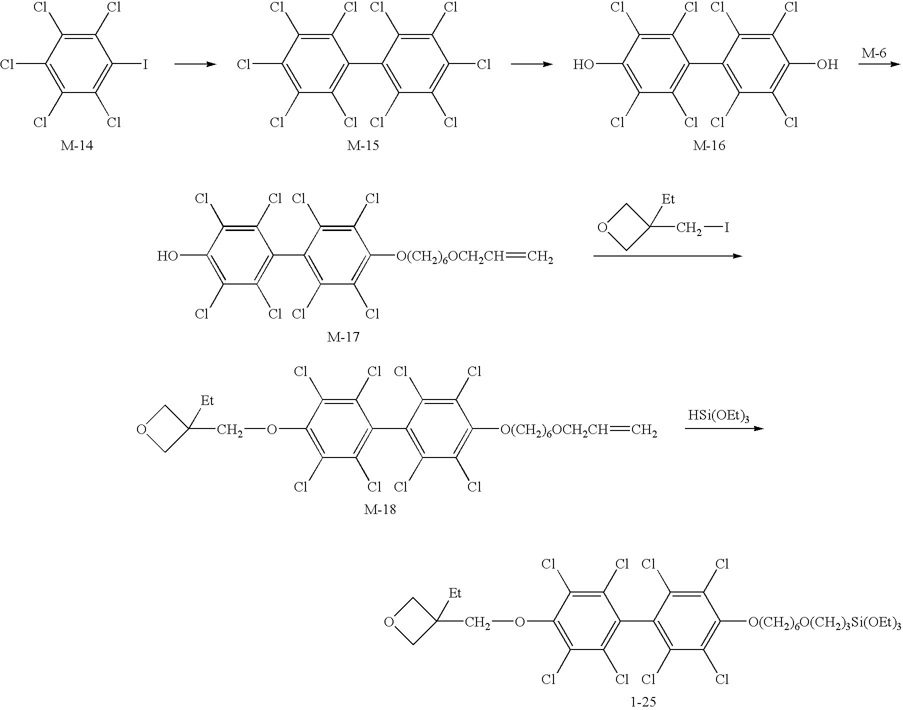
(4-1) Production of Intermediate M-15:

Pentachloroiodobenzene (M-14, by Wako Junyaku) (20.0 g, 53.2 mmol) was dissolved in 50 ml of DMF, to which was added 13.2 g of copper chloride, and this was stirred under heat at 120° C. for 8 hours. The reaction mixture was filtered, extracted with ethyl acetate and purified through column chromatography to obtain 21.5 g of the intended M-15.

(4-2) Production of Intermediate M-16:

M-15 (21.5g, 43.6mmol) obtained in the above was dissolved in 200 ml of butanol, to which was added 21.8 g of potassium hydroxide. This was stirred under heat at 100° C. for 5 hours. 200 ml of water was added to the reaction mixture, butanol was then evaporated away from it, and this was neutralized with hydrochloric acid. After filtered, this was purified through column chromatography to obtain 11.3 g of the intended M-16.

(4-3) Production of Intermediate M-17:

8.1 g of M-17 was produced in the same manner as in (2-3), for which, however, M-16 (11.3 g, 24.8 mmol) obtained in the above was used.

(4-4) Production of Intermediate M-18:

8.2 g of M-18 was produced in the same manner as in (2-4), for which, however, M-17 (8.1 g, 13.4 mmol) obtained in the above was used.

(4-5) Production of 1-25:

4.6 g of the intended 1-25 was produced in the same manner as in (2-5), for which, however, M-18 (7.8 g, 11.1 mmol) obtained in the above was used.
(5) Production of 1-26 (Scheme 5): 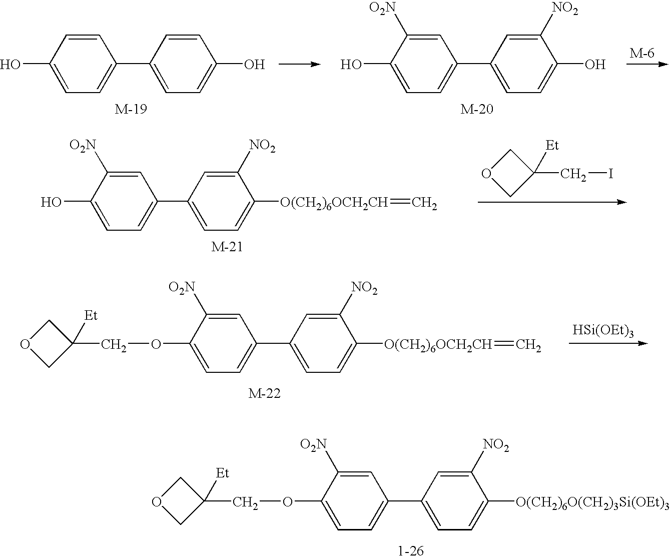
(5-1) Production of Intermediate M-20:

50 ml of water was added to bisphenol (M-19, by Tokyo Kasei) (18.6 g, 100 mmol) and 10 g of sodium sulfite, and 30 ml of concentrated hydrochloric was further added thereto. 100 ml of ethyl acetate was added to it, which was then stirred for 6 hours. The precipitated crystal was taken out through filtration, and the resulting crude crystal was recrystallized from acetonitrile to obtain 23.8 g of the intended M-20.

(5-2) Production of Intermediate M-21:

19.4 g of M-21 was produced in the same manner as in (2-3), for which, however, M-20 (23.8 g, 86 mmol) obtained in the above was used.

(5-3) Production of Intermediate M-22:

20.9 g of M-22 was produced in the same manner as in (2-4), for which, however, M-21 (19.4 g, 47 mmol) obtained in the above was used.

5 (5-4) Production of 1-26:

10.8 g of the intended 1-26 was produced in the same manner as in (2-5), for which, however, M-22 (17.8 g, 34 mmol) obtained in the above was used.
(6) Production of 1-27 (scheme 6): 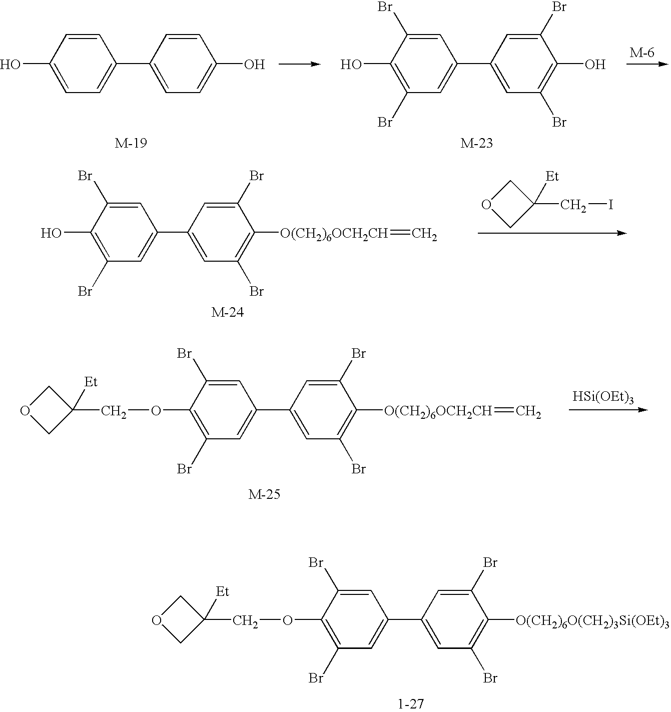
(6-1) Production of Intermediate M-23:

Bisphenol (M-19, by Tokyo Kasei) (46.6 g, 250 mmol) was dissolved in 500 ml of methylene chloride, and bromine (159.8 g, 1 mol) was added to it and stirred for 7 hours. The reaction solution was added to water with ice, and the precipitated crystal was taken out through filtration. The resulting crude crystal was recrystallized from acetonitrile to obtain 78.5 g of the intended M-23.

(6-2) Production of Intermediate M-24:

15.3 g of M-24 was produced in the same manner as in (2-3), for which, however, M-23 (28.5 g, 56.8 mmol) obtained in the above was used.

(6-3) Production of Intermediate M-25:

10.3 g of M-25 was produced in the same manner as in (2-4), for which, however, M-24 (15.3 g, 23.9 mmol) obtained in the above was used.

(6-4) Production of 1-27:

5.82 g of the intended 1-27 was produced in the same manner as in (2-5), for which, however, M-26 (10.3 g, 14 mmol) obtained in the above was used.
(7) Production of 1-28 (Scheme 7):

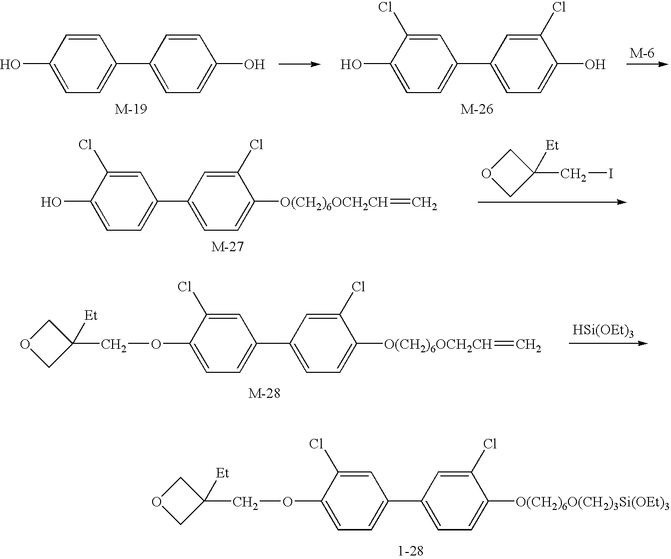

(7-1) Production of Intermediate M-26:

Bisphenol (M-19, by Tokyo Kasei) (46.6 g, 250 mmol) was dissolved in 250 ml of glacial acetic acid, to which was added chlorine (17.7 g, 250 mmol). Them, a solution of potassium bichromate (73.5 g, 250 mmol) in hydrochloric acid was added to it, and stirred at room temperature for 6 hours. The reaction solution was concentrated and the resulting crude crystal was recrystallized from water to obtain 17.9 g of the intended M-26.

(7-2) Production of Intermediate M-27:

13.6 g of M-27 was produced in the same manner as in (2-3), for which, however, M-26 (17.9 g, 70.2 mmol) obtained in the above was used.

(7-3) Production of Intermediate M-28:

10.9 g of M-28 was produced in the same manner as in (2-4), for which, however, M-27 (13.6 g, 34.4 mmol) obtained in the above was used.

(7-4) Production of 1-28:

6.66 g of the intended 1-28 was produced in the same manner as in (2-5), for which, however, M-28 (10.9 g, 22 mmol) obtained in the above was used.
(8) Production of 1-29 (Scheme 8): 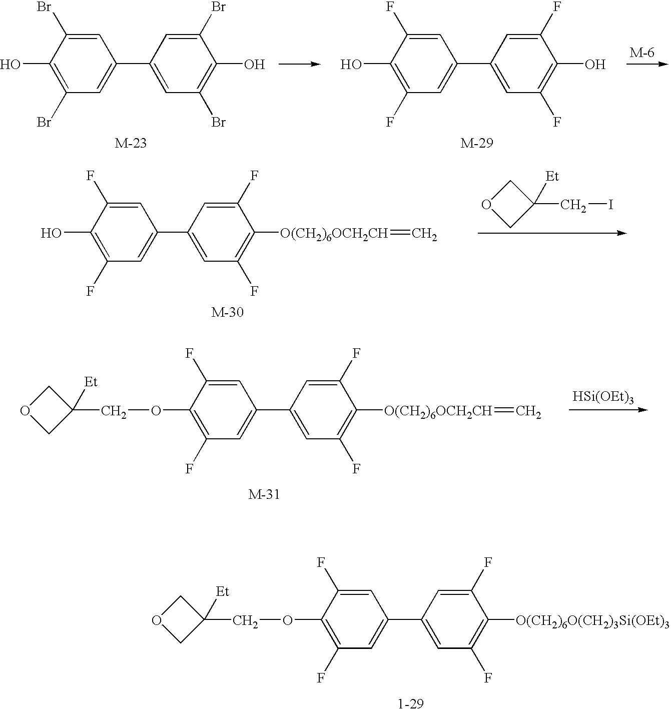
(8-1) Production of Intermediate M-29:

180 ml of sulforane was added to 30.6 g of sodium fluoride to prepare a suspension, and 200 ml of a sulforane solution of M-23 (91.6 g, 182 mmol) obtained in (6-1) was dropwise added to it, and stirred at 100° C. for 2 hours. This was further stirred under heat at 150° C. for 2 hours and then at 200° C. for 3 hours, and thereafter the reaction solvent was evaporated away under reduced pressure. Ethyl acetate was added to the resulting residue, which was then washed with water and purified through column chromatography to obtain 10.3 g of the intended M-29.

(8-2) Production of Intermediate M-30:

7.3 g of M-30 was produced in the same manner as in (2-3), for which, however, M-29 (10.3 g, 40 mmol) obtained in the above was used.

(8-3) Production of Intermediate M-31:

5.9 g of M-31 was produced in the same manner as in (2-4), for which, however, M-30 (7.3 g, 18.4 mmol) obtained in the above was used.

(8-4) Production of 1-29:

3.7 g of the intended 1-29 was produced in the same manner as in (2-5), for which, however, M-31 (5.9 g, 11.8 mmol) obtained in the above was used.

### EXAMPLE 2-1

Formation of Proton-Conductive Material:

(1) Formation of Proton Conductor (E-1) (The Invention:

800 μl of xylene was added to 2000 μl of a solvent IPA with 655.4 mg of compound (1-5) and 354.8 mg of compound (2-5) therein, and dissolved at 65° C., and then 748 μl of aqueous 35% hydrogen peroxide was added to it. This was stirred at 65° C. for 5 hours. While still hot, this was filtered through a cotton plug, and then cast on a polyimide film (Upilex-75S by Ube Kosan). This was dried at room temperature for 45 hours. Thus solidified, the coating film was peeled from the polyimide film, and a pale yellow film having a thickness of 109 nm was thus obtained. With a polarizing microscope, fine domains of optical anisotropy were confirmed in the film. From this, it is understood that the mesogen part of the compound (1-5) aggregated in a predetermined direction and its aggregates formed the film.

(2) Formation of Proton Conductor (E-2) (The Invention):

A pale yellow film having a thickness of 118 nm was produced in the same manner as that for (E-1), for which, however, 800 μl of xylene was added to 2000 μl of the solvent IPA with 625.6 m g of compound (1-5) and 406.5 mg of compound (2-5) therein, and dissolved at 65° C., and then 857 μl of aqueous 35% hydrogen peroxide was added to it.

(3) Formation of Proton Conductor (E-3) (The Invention):

A pale yellow film having a thickness of 124 nm was produced in the same manner as that for (E-1), for which, however, 800 μl of xylene was added to 2000 μl of the solvent IPA with 720.8 m g of compound (1-6) and 379.0 mg of compound (2-5) therein, and dissolved at 65° C., and then 800 μl of aqueous 35% hydrogen peroxide was added to it.

(4) Formation of Proton Conductor (E-4) (The Invention):

A pale yellow film having a thickness of 116nm was produced in the same manner as that for (E-1), for which, however, 800 μl of xylene was added to 2000 μl of the solvent IPA with 625.6 m g of compound (1-21) and 406.5 mg of compound (2-5) therein, and dissolved at 65° C., and then 857 μl of aqueous 35% hydrogen peroxide was added to it.

(5) Formation of proton conductor (E-5) (the invention):

A pale yellow film having a thickness of 123 nm was produced in the same manner as that for (E-1), for which, however, 800 μl of xylene was added to 2000 μl of the solvent IPA with 617.9 m g of compound (1-25) and 341.0 mg of compound (2-5) therein, and dissolved at 65° C., and then 857 μl of aqueous 35% hydrogen peroxide was added to it.

(6) Formation of Proton Conductor (E-6) (The Invention):

A pale yellow film having a thickness of 127 nm was produced in the same manner as that for (E-1), for which, however, 800 μl of xylene was added to 2000 μl of the solvent IPA with 678.8 mg of compound (1-26) and 483.9 mg of compound (2-5) therein, and dissolved at 65° C., and then 857 μl of aqueous 35% hydrogen peroxide was added to it.

(7) Formation of Proton Conductor (E-7) (The Invention):

A pale yellow film having a thickness of 118 nm was produced in the same manner as that for (E-1), for which, however, 800 μl of xylene was added to 2000 μl of the solvent IPA with 633.1 mg of compound (1-27) and 338.7 mg of compound (2-5) therein, and dissolved at 65° C., and then 857 μl of aqueous 35% hydrogen peroxide was added to it.

(8) Formation of Proton Conductor (E-8) (The Invention):

A pale yellow film having a thickness of 132 nm was produced in the same manner as that for (E-1), for which, however, 800 μl of xylene was added to 2000 μl of the solvent IPA with 657.7 mg of compound (1-28) and 483.9 mg of compound (2-5) therein, and dissolved at 65° C., and then 857 μl of aqueous 35% hydrogen peroxide was added to it.

(9) Formation of Proton Conductor (E-9) (The Invention):

A pale yellow film having a thickness of 116 nm was produced in the same manner as that for (E-1), for which, however, 800 μl of xylene was added to 2000 μl of the solvent IPA with 660.8 m g of compound (1-29) and 483.9 mg of compound (2-5) therein, and dissolved at 65° C., and then 857 μl of aqueous 35% hydrogen peroxide was added to it. (10) Formation of proton conductor (R-1) (comparative sample):

An yellowish brown film having a thickness of 114 nm was produced in the same manner as that for (E-1), for which, however, 800 μl of xylene was added to 2000 μl of the solvent IPA with 554.0 mg of compound (X-15) and 415.0 mg of compound (2-5) therein, and dissolved at 65° C., and then 874 μl of aqueous 35% hydrogen peroxide was added to it.

2. Resistance to Aqueous Methanol Solution:

Circular discs having a diameter of 13 mm were blanked out of the thus-obtained proton conductors (E-1 to E-9), comparative proton conductor (R-1) and Nafion 117 (by DuPont), and these samples were separately dipped in 5 ml of an aqueous 10 mas. % methanol solution for 48 hours. The proton conductors (E-1 to E-9) of the invention and the comparative sample (R-1) swelled little, but opposed to them, Nafion 117 swelled by about 70% by mass and its shape deformed. From this, it is understood that the proton conductors of the invention are sufficiently resistant to aqueous methanol solution that serves as fuel in direct methanol fuel cells.

3. Determination of Methanol Perviousness:

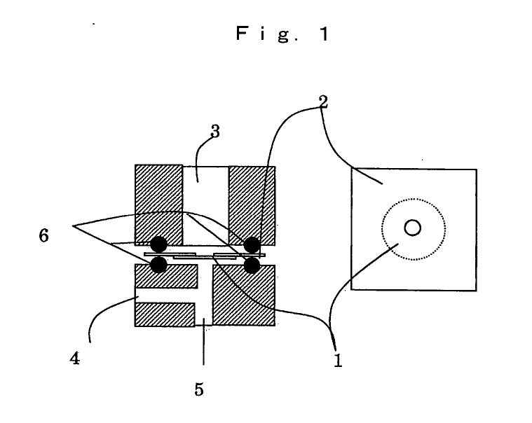

Circular discs having a diameter of 13 mm were blanked out of the proton conductors. (E-1 to E-9), comparative proton conductor (R-1) and Nafion 117 (by DuPont), and these samples were reinforced with a Teflon® tape having a circular hole (diameter, 5 mm) formed therein. The reinforced membrane was fitted to a stainless cell as in FIG. 1, and aqueous methanol solution was put into the upper space above the membrane, and a hydrogen gas was fed thereinto through a lower gas inlet slit at a constant flow rate. The amount of methanol having passed through the membrane was determined with a gas chromatography device of which the detector was connected to the lower detection slit. In FIG. 1; 1 is a proton conductor, 2 is a reinforcing Teflon tape, 3 is a path for aqueous methanol injection, 4 is a carrier gas inlet slit, 5 is a detection slit (connected to a gas chromatography device), 6 is a rubber gasket. The results are given in Table 1. The methanol concentration in the Table is a relative value based on the standard amount (1) from Nafion 117.

TABLE 1

| Proton-Conductive | Methanol Concentration | | | |
|---|---|---|---|---|
| Membrane | 4.6 mas % | 18.6 mas % | 46 mas % | Remarks |
| R-1 | 0.18 | 0.21 | 0.24 | comparison |
| E-1 | 0.15 | 0.17 | 0.2 | invention |
| E-2 | 0.14 | 0.16 | 0.18 | invention |
| E-3 | 0.12 | 0.13 | 0.15 | invention |
| E-4 | 0.13 | 0.15 | 0.17 | invention |
| E-5 | 0.15 | 0.18 | 0.21 | invention |
| E-6 | 0.13 | 0.15 | 0.18 | invention |
| E-7 | 0.14 | 0.15 | 0.19 | invention |
| E-8 | 0.12 | 0.13 | 0.17 | invention |
| E-9 | 0.13 | 0.14 | 0.18 | invention |

(Result)

Table 1 confirms that the methanol perviousness of the proton conductors of the invention is at most ⅕ of that of Nafion 117, and that the proton conductors of the invention are superior to R-1 as reducing the methanol perviousness thereof by 20 to 40% or so.

4. Determination of Ionic Conductivity:

Circular discs having a diameter of 13 mm were blanked out of the proton conductors (E-1 to E-9), comparative proton conductor (R-1) and Nafion 117 (by DuPont). Sandwiched between two stainless plates, the ionic conductivity of each of these samples was measured at 25° C. and at a relative humidity of 95% according to an AC impedance process. The results are given in Table 2.

TABLE 2

| Proton-Conductive | Ionic Conductivity × 10⁻³ | |
|---|---|---|
| Membrane | S/cm | Remarks |
| E-1 | 4.28 | invention |
| E-2 | 7.32 | invention |
| E-3 | 6.28 | invention |
| E-4 | 7.14 | invention |
| E-5 | 5.21 | invention |
| E-6 | 5.83 | invention |
| E-7 | 6.18 | invention |
| E-8 | 6.18 | invention |
| E-9 | 6.38 | invention |
| R-1 | 0.93 | comparison |
| Nafion 117 | 6.7 | comparison |

(Result)

Table 2 confirms that the ionic conductivity of the proton-conductive membranes of the invention is on the same level as that of Nafion 117 and is higher than that of the comparative hybrid membrane (R-1) not substituted with an electron-attracting group.

5. Film Durability Test:

Circular discs having a diameter of 13 mm were blanked 10 out of the proton conductors (E-1 to E-9) and comparative proton conductor (R-1). Each sample was sandwiched between two stainless plates, and a pressure of 3 MPa, which corresponds to the pressure to be applied to a proton-conductive film in fabricating MEA (membrane electrode assembly) for fuel cells, was applied thereto by the use of a hand-powered film pressure gauge. As a result, the comparative sample (R-1) not having an electron-attracting group was cracked, but the samples (E-1 to E-9) of the invention were neither cracked nor damaged owing to the pressure application thereto, since the substituted mesogen in the film was substituted with an electron-attracting group, fluorine atom and therefore the organosilicon-containing precursor was not damaged and the film structure of the sample was well kept as such even after pressure application thereto.

6. Acid Release Test:

The acid release test was carried out as follows: About 100 mg of a film sample was cut out, dipped in 50 ml of water, and heated at 50° C. for 8 hours (A) or at 100° C. for 5 hours (B). From the pH value of the aqueous solution, the molar amount of the dissolved acid component was estimated, and the acid component released from the sample was computed from the molar amount of the acid component in the original film calculated from the amount of the film tested.

TABLE 3

| Proton-Conductive | | |
|---|---|---|
| Membrane | Release Rate A (%) | Release Rate B (%) |
| E-1 | 27 | 14 |
| E-2 | 18 | 7 |
| E-3 | 14 | 6 |
| E-4 | 23 | 11 |
| E-5 | 21 | 10 |
| E-6 | 19 | 9 |
| E-7 | 22 | 10 |
| E-8 | 26 | 12 |
| E-9 | 19 | 8 |
| R-1 | 38 | 17 |

(Result)

Table 3 confirms that, owing to the electron-attracting group introduced thereinto to retard compound decomposition, the acid release from the proton-conductive membranes (E-1 to E-9) of the invention is smaller than that from the comparative hybrid membrane (R-1) not substituted with an electron-attracting group.

What is claimed is:

1. A proton-conductive material which contains a compound having a mesogen substituted with an electron-attracting group.

2. The proton-conductive material as claimed in claim 1, which contains a compound having a structure wherein both an organic molecular chain containing a mesogen substituted with an electron-attracting group and a group containing a proton-donating group bond to a silicon-oxygen three-dimensional crosslinked matrix through a covalent bond.

3. The proton-conductive material as claimed in claim 1, which contains aggregate having a structure wherein both an organic molecular chain containing a mesogen substituted with an electron-attracting group and a group containing a proton-donating group bond to a silicon-oxygen three-dimensional crosslinked matrix through a covalent bond, and wherein at least a part of the organic molecular chain is oriented.

4. The proton-conductive material as claimed in claim 1, which is produced by polymerizing at least a compound of the following formula (1):
(Z¹)ₙ₁-A-[Si (OR¹)ₘ₁(R²)₃₋ₘ₁]ₙ₂ (1)
wherein A¹ represents an organic group containing a mesogen substituted with at least one electron-attracting group; R¹ represents an alkyl group or an aryl group; R² represents an alkyl group, an aryl group, or a heterocyclic group; Z¹ represents a substituent capable of forming a carbon-carbon bond or a carbon-oxygen bond through polymerization; m1 indicates an integer of from 1 to 3; n2 indicates an integer of from 1 to 3; when the formula has two or more Z¹'s, R¹'s and R²'s, then they may be the same or different; and n1 indicates an integer of from 0 to 3.

5. The proton-conductive material as claimed in claim 4, wherein A¹ in formula (1) contains a structure of any of the following formulae (A-1) to (A-5): 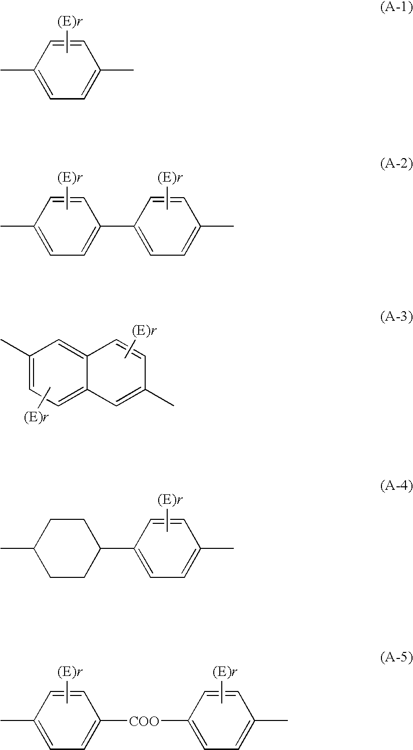
wherein E represents an electron-attracting group, and r indicates an integer of 1 or more.

6. The proton-conductive material as claimed in claim 5, wherein A¹ in formula (1) has a structure of the following formula (2):
-[Q¹¹-Y¹¹-Q¹²]ₘ₉- (2)
wherein Q¹¹ and Q¹² each represent a divalent linking group or a single bond; Y¹¹ represents any of (A-1) to (A-5); and m9 indicates an integer of from 1 to 3.

7. The proton-conductive material as claimed in claim 4, which is produced by polymerizing at least the compound of formula (1) and a compound of the following formula (3):
L-(S)ₚ-B-[Si(OR³)₃₋ₘ₂(R⁴)ₘ₂]ₙ₂ (3)
wherein B represents an organic group containing an aliphatic group and/or an aromatic group; R³ represents an alkyl group or an aryl group; R⁴ represents an alkyl group, an aryl group or a heterocyclic group; m2 indicates an integer of from 1 to 3; n2 indicates an integer of from 1 to 4; p indicates an integer of from 1 to 5; when p is 1, then L represents a hydrogen atom or —COCH₃, and when p is an integer of from 2 to 5, then L represents an alkyl group, an aryl group, a heterocyclic group, or [Si(OR³)₃₋ₘ₂(R⁴)ₘ₂]ₙ₂; when the formula has two or more R³'s and R⁴'s, then they may be the same or different.

8. The proton-conductive material as claimed in claim 7, wherein B in formula (3) is an alkylene group having from 1 to 12 carbon atoms, or a phenylene group.

9. The proton-conductive material as claimed in claim 2, which has a moiety of the following formula (1-1): 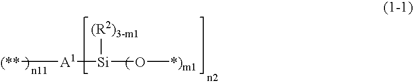
wherein A¹ represents an organic group containing a mesogen substituted with at least one electron-attracting group; R² represents an alkyl group, an aryl group or a heterocyclic group; m1 indicates an integer of from 1 to 3; n2 indicates an integer of from 1 to 3; when the formula has two or more R²'s, then they may be the same or different; n11 indicates an integer of from 0 to 3; * indicates the position at which the oxygen atom bonds to the silicon atom of the compound; and ** indicates the position at which A¹ bonds to the organic polymer chain of the compound.

10. The proton-conductive material as claimed in claim 2, which has a moiety of the following formula (3-1): 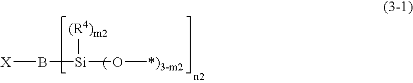
wherein X represents a proton-donating group; B represents an organic group containing an aliphatic group and/or an aromatic group; R⁴ represents an alkyl group, an aryl group or a heterocyclic group; m2 indicates an integer of from 1 to 3; n2 indicates an integer of from 1 to 4; * indicates the position at which the oxygen atom bonds to the silicon atom of the compound; and when the formula has two or more R⁴'s, then they may be the same or different.

11. The proton-conductive material as claimed in claim 1, wherein the electron-attracting group is at least one or more of F, Cl, Br, I, CN, NO₂, COCH₃, CₙF₂ₙ₊₁ (where n indicates an integer of from 1 to 4), and SO₃H.

12. The proton-conductive material as claimed in claim 2, wherein the proton-donating group is a sulfonic acid group.

13. The proton-conductive material as claimed in claim 2, wherein the mesogen is represented by any of the following formulae (A-1) to (A-5): 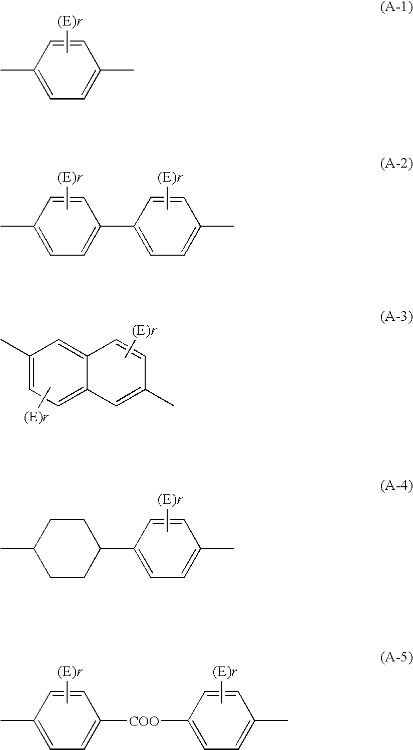
wherein E represents an electron-attracting group, and r indicates an integer of 1 or more.

14. A method for producing a proton-conductive material, which comprises reacting and polymerizing a compound of the following formula (1) and an oxide of a compound of the following formula (3) in a mode of sol-gel reaction:
(Z¹)ₙ₁-A-[Si(OR¹)ₘ₁(R²)₃₋ₘ₁]ₙ₂ (1)
wherein A¹ represents an organic group containing a mesogen substituted with at least one electron-attracting group; R¹ represents an alkyl group or an aryl group; R² represents an alkyl group, an aryl group, or a heterocyclic group; Z¹ represents a substituent capable of forming a carbon-carbon bond or a carbon-oxygen bond through polymerization; m1 indicates an integer of from 1 to 3; n2 indicates an integer of from 1 to 3; when the formula has two or more Z¹'s, R¹'s and R²'s, then they may be the same or different; and n1 indicates an integer of from 0 to 3,
(3) L-(S)ₚ-B-[Si(OR³)₃₋ₘ₂(R⁴)ₘ₂]ₙ₂ (3)
wherein B represents an organic group containing an aliphatic group and/or an aromatic group; R³ represents an alkyl group or an aryl group; R⁴ represents an alkyl group, an aryl group or a heterocyclic group; m2 indicates an integer of from 1 to 3; n2 indicates an integer of from 1 to 4; p indicates an integer of from 1 to 5; when p is 1, then L represents a hydrogen atom or —COCH₃, and when p is an integer of from 2 to 5, then L represents an alkyl group, an aryl group, a heterocyclic group, or [Si(OR³)₃₋ₘ₂(R⁴⁾ₘ₂]ₙ₂; when the formula has two or more R³'s and R⁴'s, then they may be the same or different.

15. The method for producing a proton-conductive material as claimed in claim 14, wherein the oxide of a compound of formula (3) contains a sulfone group.

16. The method for producing a proton-conductive material as claimed in claim 14, wherein a mixture of a compound of formula (1) and an oxide of a compound of formula (3) is cast on a support and reacted in a mode of sol-gel reaction thereon.

17. The method for producing a proton-conductive material as claimed in claim 14, wherein a mixture of a compound of formula (1), a compound of formula (3) and an oxidizing agent is cast on a support and reacted in a mode of sol-gel reaction thereon.

18. The method for producing a proton-conductive material as claimed in claim 16, wherein the support is a support processed for orientation.

19. A membrane electrode assembly which has the proton-conductive material of claim 1 between the anode and the cathode.

20. A fuel cell which has the membrane electrode assembly of claim 19.
